(19) United States
(12) Patent Application Publication
(10) Pub. No.: US 2023/0239072 A1
(43) Pub. Date: Jul. 27, 2023

(54) TRANSMISSION OF REVERSE-LINK GRANTS FOR ANCHOR BASED SIDELINK COMMUNICATION

(71) Applicant: QUALCOMM Incorporated, San Diego, CA (US)

(72) Inventors: Changlong XU, Beijing (CN); Jing SUN, San Diego, CA (US); Xiaoxia ZHANG, San Diego, CA (US)

(21) Appl. No.: 17/999,644

(22) PCT Filed: Jul. 15, 2020
(86) PCT No.: PCT/CN2020/102099

§ 371 Date: Nov. 22, 2022

(51) Int. Cl. H04L 1/00; H04L 5/00; H04W 72/25

(52) U.S. Cl. CPC H04L 1/0013; H04L 5/0051; H04W 72/25

(57) ABSTRACT

Wireless communications systems and methods related to transmission of reverse-link grants for anchor based sidelink communication are provided. A first user equipment (UE) determines a plurality of reverse-link grants for a respective plurality of UEs. The first UE transmits first sidelink control information (SCI) over a physical sidelink control channel (PSCCH). The first SCI may indicate whether user data follows in the physical sidelink shared channel (PSSCH). The first UE transmits a demodulation reference signal (DMRS) and second SCI over the PSSCH. The second SCI comprises the plurality of reverse-link grants in a block. The second SCI is rate matched from a with the DMRS and the third SCI being rate matched from the start of the PSSCH and including the block of reverse-link grants.

### TECHNICAL FIELD

This application relates to wireless communication systems, and more particularly to the transmission of reverse-link grants by an anchor user equipment (UE) to client UEs.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

In a wireless communication network, a BS may communicate with a UE in an uplink direction and a downlink direction. Sidelink was introduced to allow a UE to send data to another UE without tunneling through the BS and/or an associated core network. Sidelink technology had been extended to provision for device-to-device (D2D) communications, vehicle-to-everything (V2X) communications, and/or cellular vehicle-to-everything (C-V2X) communications. Similarly, NR may be extended to support sidelink communications for D2D, V2X, and/or C-V2X over a dedicated spectrum, a licensed spectrum, and/or an unlicensed spectrum.

In scenarios where one UE serves as an anchor UE to other UEs engaged in sidelink communications, the anchor UE may assume a scheduling role for other UEs engaged in sidelink communications. However, problems may arise when the anchor UE seeks to provide reverse link grants to multiple UEs, which may waste payload resources and/or find only limited use that misses some scenarios (such as where there is no forward link data for transmission). Thus, there is a need to provide techniques for conveying reverse link grants to multiple UEs in a more efficient manner.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication includes determining, by a first user equipment (UE), a plurality of reverse-link grants for a respective plurality of UEs to transmit sidelink data to the first UE. The method further includes transmitting, by the first UE, first sidelink control information over a physical sidelink control channel (PSCCH). The method further includes transmitting, by the first UE over a physical sidelink shared channel (PSSCH), a demodulation reference signal (DMRS) and second sidelink control information, the second sidelink control information comprising the plurality of reverse-link grants in a block.

In an additional aspect of the disclosure, a method of wireless communication includes determining, by a first user equipment (UE), a plurality reverse-link grants for a plurality of UEs to transmit sidelink data to the first UE. The method further includes transmitting, by the first UE, first sidelink control information over a physical sidelink control channel (PSCCH). The method further includes transmitting, by the first UE over the PSSCH: a demodulation reference signal (DMRS); second sidelink control information configured to provide information related to third sidelink control information; and the third sidelink control information comprising the plurality of reverse-link grants in a block.

In an additional aspect of the disclosure, a user equipment (UE) includes a processor configured to determine a plurality of reverse-link grants for a respective plurality of UEs to transmit sidelink data to the user equipment. The user equipment further includes a transceiver configured to transmit first sidelink control information over a physical sidelink control channel (PSCCH). The transceiver is further configured to transmit, over a physical sidelink shared channel (PSSCH), a demodulation reference signal (DMRS) and second sidelink control information, the second sidelink control information comprising the plurality of reverse-link grants in a block.

In an additional aspect of the disclosure, a user equipment (UE), includes a processor configured to determine a plurality reverse-link grants for a plurality of UEs to transmit sidelink data to the user equipment. The user equipment further includes a transceiver configured to transmit first sidelink control information over a physical sidelink control channel (PSCCH). The transceiver is further configured to transmit over a physical sidelink shared channel (PSSCH): a demodulation reference signal (DMRS); second sidelink control information configured to provide information related to third sidelink control information; and the third sidelink control information comprising the plurality of reverse-link grants in a block.

In an additional aspect of the disclosure, a non-transitory computer-readable medium is provided having program code recorded thereon. The program code comprises code for causing a first user equipment (UE) to determine a plurality of reverse-link grants for a respective plurality of UEs to transmit sidelink data to the first UE. The program code further comprises code for causing the first UE to transmit first sidelink control information over a physical sidelink control channel (PSCCH). The program code further comprises code for causing the first UE to transmit, over a physical sidelink shared channel (PSSCH), a demodulation reference signal (DMRS) and second sidelink control information, the second sidelink control information comprising the plurality of reverse-link grants in a block.

In an additional aspect of the disclosure a non-transitory computer-readable medium is provided having program code recorded thereon. The program code comprises code for causing a first user equipment (UE) to determine a plurality reverse-link grants for a plurality of UEs to transmit sidelink data to the first UE. The program code further comprises code for causing the first UE to transmit first sidelink control information over a physical sidelink control channel (PSCCH). The program code further comprises code for causing the first UE to transmit, over a physical sidelink shared channel (PSSCH): a demodulation reference signal (DMRS); second sidelink control information configured to provide information related to third sidelink control information; and the third sidelink control information comprising the plurality of reverse-link grants in a block.

In an additional aspect of the disclosure, a user equipment includes means for determining a plurality of reverse-link grants for a respective plurality of UEs to transmit sidelink data to the user equipment. The user equipment further includes means for transmitting first sidelink control information over a physical sidelink control channel (PSCCH). The user equipment further includes means for transmitting, over a physical sidelink shared channel (PSSCH), a demodulation reference signal (DMRS) and second sidelink control information, the second sidelink control information comprising the plurality of reverse-link grants in a block.

In an additional aspect of the disclosure, a user equipment (UE), includes means for determining a plurality reverse-link grants for a plurality of UEs to transmit sidelink data to the user equipment. The user equipment further includes means for transmitting first sidelink control information over a physical sidelink control channel (PSCCH). The user equipment further includes means for transmitting over a physical sidelink shared channel (PSSCH): a demodulation reference signal (DMRS); second sidelink control information configured to provide information related to third sidelink control information; and the third sidelink control information comprising the plurality of reverse-link grants in a block.

Other aspects, features, and embodiments of the present invention will become apparent to those of ordinary skill in the art upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a wireless communication network that provisions for sidelink communications according to some aspects of the present disclosure.

FIG. 3 illustrates a sidelink communication scheme according to some aspects of the present disclosure.

FIG. 4 is a simplified block diagram of an exemplary slot according to some aspects of the present disclosure.

FIG. 5 is a block diagram of an exemplary client user equipment (UE) according to some aspects of the present disclosure.

FIG. 6 is a block diagram of an exemplary anchor UE according to some aspects of the present disclosure.

FIG. 7 is a flow diagram of a first reverse-link grant transmission process according to some aspects of the present disclosure.

FIG. 8 is a block diagram of sidelink resources having a reverse-link grant according to some aspects of the present disclosure.

FIG. 9 is a flow diagram of a process for transmitting the second stage control information according to a rate matching rule according to some aspects of the present disclosure.

FIG. 10 is a block diagram of sidelink resources having a reverse-link grant according to some aspects of the present disclosure.

FIG. 11 is a flow diagram of a second reverse-link grant transmission process according to some aspects of the present disclosure.

FIG. 12 is a block diagram of sidelink resources having a reverse-link grant according to some aspects of the present disclosure.

FIG. 13 is a flow diagram of a third reverse-link grant transmission process according to some aspects of the present disclosure.

FIG. 14 is a block diagram of sidelink resources having a reverse-link grant according to some aspects of the present disclosure.

FIG. 15 is a block diagram of sidelink resources having a reverse-link grant according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., −1 M nodes/km²), ultra-low complexity (e.g., −10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., −0.99.9999% reliability), ultra-low latency (e.g., ˜1 ms), and users with wide ranges of mobility or lack thereof; and (3) with enhanced mobile broadband including extreme high capacity (e.g., −10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network (e.g., via a PC5 link instead). Sidelink communication can be communicated over a physical sidelink control channel (PSCCH) and a physical sidelink shared channel (PSSCH). The PSCCH is analogous to a physical downlink control channel (PDCCH) and the PSSCH to a physical downlink shared channel (PDSCH) in downlink (DL) communication between a BS and a UE. For instance, the PSCCH may carry sidelink control information (SCI) and the PSSCH may carry sidelink data. Each PSCCH is associated with a corresponding PSSCH, where SCI in a PSCCH may carry scheduling information for sidelink data transmission in the associated PSSCH. In some examples, a UE may transmit PSSCH carrying SCI, which may be indicated in multiple stages (e.g., two stages, three stages, and/or the like).

In a first stage control (also referred to herein as SCI-1), the UE may transmit PSCCH carrying information for resource allocation and decoding a second stage control. The first stage SCI may include at least one of a priority, PSSCH resource assignment, resource reservation period (if enabled), PSSCH DMRS pattern (if more than one pattern is configured), a second-stage SCI format (e.g., size of a second SCI), an amount of resources for the second-stage SCI, a number of PSSCH demodulation reference signal (DMRS) port(s), a modulation and coding scheme (MCS), etc. In a second stage control (also referred to herein as SCI-2), the UE may transmit information for decoding the user data on PSSCH. The SCI-2 may include a 16-bit L1 destination identifier (ID), an 8-bit L1 source ID, a HARQ process ID, a new data indicator (NDI), a redundancy version (RV), etc. Sidelink communication can also be communicated over a physical sidelink feedback control channel (PSFCH), which indicates an acknowledgement (ACK)-negative acknowledgement (NACK) for a previously transmitted PSSCH. Use cases for sidelink communication may include vehicle-to-everything (V2X), industrial IoT (IIoT), and/or NR-lite (to name a few examples).

As used herein, the term “sidelink UE” can refer to a user equipment device performing a device-to-device communication or other types of communications with another user equipment device independent of any tunneling through the BS (e.g., gNB) and/or an associated core network. As used herein, the terms “sidelink transmitting UE” and “transmitting UE” can refer to a user equipment device performing a sidelink transmission operation. As used herein, the terms “sidelink receiving UE” and “receiving UE” can refer to a user equipment device performing a sidelink reception operation. As used herein, the terms “anchor UE” or “sidelink anchor UE” can refer to a sidelink UE designated as an anchor node with a stand-alone sidelink configuration that can initiate sidelink operations autonomously (e.g., independent of any cell and/or associated core network), and the terms are interchangeable without departing from the scope of the present disclosure.

NR supports multiple modes of radio resource allocations (RRA), including a mode-1 RRA and a mode-2 RRA, for sidelink over a licensed spectrum. The mode-1 RRA supports network controlled RRA that can be used for in-coverage sidelink communication. For instance, a serving BS (e.g., gNB) may determine a radio resource on behalf of a sidelink UE and transmit an indication of the radio resource to the sidelink UE. In some aspects, the serving BS grants a sidelink transmission with downlink control information (DCI). For this mode, however, there is significant base station involvement and is typically operable when the sidelink UE is within the coverage area of the serving BS, but not necessarily for out-of-coverage sidelink scenarios. The mode-2 RRA supports autonomous RRA that can be used for out-of-coverage sidelink UEs or partial-coverage sidelink UEs. For instance, an out-of-coverage sidelink UE or a partial-coverage UE may be preconfigured with a sidelink resource pool and may select a radio resource from the preconfigured sidelink resource pool for sidelink communication. For this mode, it may be possible for V2X systems to operate independent of the serving BS. However, the mode-2 RRA relies on the sidelink settings across different environments (e.g., vehicles). For instance, this mode may require the sidelink settings to be uniform so that each sidelink UE (e.g., vehicle) can communicate with one another. This would rely on equipment user vendors (e.g., different automotive manufacturers) to coordinate and implement common sidelink settings. This may pose a substantial burden on the equipment user vendors to develop and implement a uniform sidelink setting so that NR-U sidelink user equipment devices can communicate via respective sidelink connections. As such, there is a desire to deploy the NR-U sidelink system as a stand-alone system.

A stand-alone system may include a sidelink UE designated as an anchor UE (e.g., an anchor node). The anchor UE may initiate sidelink operations with one or more client UEs autonomously (e.g., independent of any cell and/or associated core network). Accordingly, the anchor UE may announce system parameters (e.g., information associated with a sidelink master information block (SL-MIB), remaining minimum system information (RMSI), primary synchronization signal (PSS), secondary synchronization signal (SSS), and/or the like) for the operation of each of the client UEs, and the anchor UE may provide respective radio resource control (RRC) configurations for corresponding client UEs. For example, the anchor UE may provide first RRC configurations to a first client UE and different second RRC configurations to a second client UE. Moreover, while the anchor UE may interface with the client UEs using mode-1 RRA or mode-2 RRA, the signaling received by the client UEs may remain the same between the two modes.

In NR vehicle-to-everything (V2X), a client UE (e.g., transmitting UE) may initiate SCI and sidelink data transmission to an anchor UE (e.g., a receiving UE). The client UE may select resources for the sidelink transmission based on channel sensing and channel measurements. The sensing and channel measurements performed by the client UE may present channel conditions and/or interference at the client UE, but may not necessarily represent channel conditions and/or interference experienced by the anchor UE where data is being received and decoded. Accordingly, a resource selected by the client UE may not be a most suitable resource for the anchor UE. Instead, in an anchor-client architecture it may be preferred to allow the anchor UE to schedule transmissions from client UE to anchor UE for better efficiency—this connection from client UE to anchor UE may be referred to herein as a reverse link (with the link from the anchor UE to the client UE referred to herein as the forward link, for example).

The present application describes mechanisms for the transmission of one or more reverse-link grants from an anchor UE to facilitate sidelink communications between the anchor UE and one or more client UEs. Each reverse-link grant may specify scheduling information, such as information indicating a sidelink resource (e.g., a time-frequency resource) and/or transmission parameters (e.g., modulation coding scheme (MCS) and/or demodulation reference signal (DMRS) pattern) for sidelink transmission from a corresponding client UE to the anchor UE. Accordingly, the anchor UE may initiate a sidelink communication by transmitting the scheduling information to a client UE for the sidelink transmission. Upon receiving the scheduling information included in the reverse-link grant, the client UE may transmit sidelink data to the anchor UE according to the received reverse-link grant. As the number of client UEs associated with the anchor UE and/or the number of reverse-link grants the anchor UE is configured to transmit increases, the resources on the PSSCH available for user data transmission decrease.

Accordingly, in some embodiments, reverse-link grants may be transmitted by the anchor UE in the form of shared SCI conveyance. More specifically, the anchor UE may aggregate the one or more reverse-link grants into a block and transmit, over the PSSCH, the block in the SCI-2 or within third stage control information (also referred to herein as SCI-3). In some instances, the anchor UE may also transmit information regarding the block, such as a presence of the block, a size of the block, a number of reverse-link grants included in the block, and/or the like within a preceding stage of control information. For example, the anchor UE may include in SCI-1 the information regarding the block in instances where the SCI-2 contains the block, and the SCI-2 may include the information regarding the block in instances where the SCI-3 contains the block. To that end, transmitting the block of reverse-link grants may involve adding data fields to and/or modifying existing data fields of the SCI-1 and/or the SCI-2.

Moreover, the anchor UE may rate match the SCI containing the reverse-link grants (e.g., SCI-2 or SCI-3) according to a modified rate matching rule (e.g., where a demodulation reference signal does not start at the beginning of PSSCH). Rate matching the SCI according to the rate matching rule may involve rate matching from a particular position on the PSSCH such that the SCI occupies a certain set of resource elements on the PSSCH following that position. For example, where there is no user data to transmit on a forward link to one or more client UEs, the anchor UE may rate match the SCI (e.g., SCI-2 or SCI-3) from the beginning of the PSSCH in situations where the DMRS starts later. In this way, the first symbols within the slot are not wasted (i.e., empty). In another example, the anchor UE may rate match the SCI (e.g., SCI-2 or SCI-3) from the DMRS in situations where the DMRS starts later, and rate match back to the start of the PSSCH (e.g., before the DMRS starts) to still use those first symbols that would otherwise be left empty. Further, the reverse-link grants may be transmitted along with or independent of user data. To that end, rate matching the SCI according to the rate matching rule may involve accommodating the transmission of the user data over the PSSCH. This may include adding information into the header data of SCI-1 and/or SCI-2 to allow the receiving client UE(s) to identify how many reverse-link grants are included in a given SCI block, as well as UE IDs that correspond to respective reverse-link grants in the given block.

Aspects of the present disclosure provide several benefits. For example, by aggregating multiple reverse-link grants into a single block, the resources (e.g., time-frequency resources) involved with transmitting the reverse-link grants may be reduced. Additionally, by transmitting the block of reverse-link grants in the form of SCI on the PSSCH, the block may be flexibly transmitted along with or independent of user data, such as forward link data. To that end, in some instances, the anchor UE may transmit a reverse-link grant to a client UE without having to wait for forward link communication to the client UE, thereby improving turn-around times and/or throughput. In other instances, the anchor UE may transmit the block of reverse-link grants while still accommodating user data, such as forward link data, in the same transmission. In such cases, the anchor UE may efficiently transmit both user data and the block of reverse-link grants.

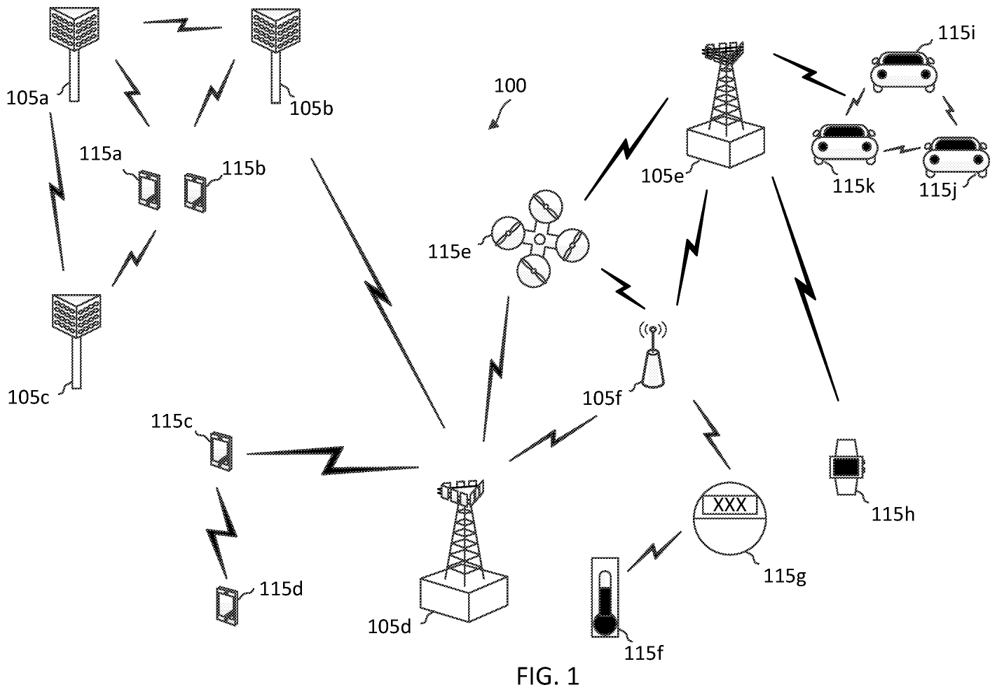

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115 (such as and including according to embodiments of the present disclosure).

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105 (e.g., PC5 etc.).

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource elements (RE)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., a PSS and a SSS) in the network 100 to facilitate synchronization. The BSs 105 can broadcast system information associated with the network 100 (e.g., including a master information block (MIB), remaining minimum system information (e.g., RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (e.g., PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT (e.g., a channel occupancy time). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

In some aspects, the network 100 may support stand-alone sidelink communication among the UEs 115 over a shared radio frequency band, in which a subset of the UEs 115 are adapted as anchor nodes (e.g., sidelink anchor UEs) and autonomously initiate sidelink operation for the UEs 115. In this respect, the sidelink anchor UEs are autonomous and can perform sidelink operations independent of any cell, such as BSs 105.

For brevity of explanation of the remainder of the description for FIG. 1, the UEs 115 configured as an anchor node are referred to as an “anchor UE” or a “sidelink anchor UE” and the remaining UEs 115 configured to receive the system information from the anchor UE are referred to as a “client UE.” In some examples, UE 115j can represent an anchor UE and UE 115k can represent a client UE (focusing on one for simplicity of illustration and discussion herein), however, the remaining UEs 115 can individually serve as an anchor UE and/or a client UE in a respective implementation without departing from the scope of the present disclosure.

The anchor UE may autonomously determine system parameter information (e.g., independently of any in-coverage cell and/or associated core network). Across different anchor UEs (e.g., UE 115j, 115d in FIG. 1), the system parameter information can be substantially the same to facilitate a coordinated deployment (e.g., IIoTs) in some embodiments, or the system information can be at least partially different for deployment of different applications in other embodiments.

In some embodiments, the anchor UE may also transmit synchronization signals (e.g., including PSS and SSS) in the network 100 to initiate a sidelink operation in the network 100 and facilitate synchronization with a client UE (e.g., 115k) that decides to join the sidelink operation. Additionally, the anchor UE may broadcast system parameter information associated with the network 100 (e.g., including a sidelink master information block (e.g., SL-MIB) and/or remaining minimum system information (e.g., RMSI) to facilitate a sidelink communication between client UEs, as well as with the anchor UE. In some instances, the anchor UE may broadcast the PSS, the SSS, and/or the SL-MIB in the form of a sidelink synchronization signal block (e.g., S-SSB) over a physical sidelink broadcast channel (e.g., PSBCH).

After obtaining the SL-MIB and/or the RMSI, the client UE can perform a sidelink communication procedure to establish a sidelink connection with the anchor UE. For example, the anchor UE may allocate radio resources to the client UE for sidelink communications via information included in the RMSI. The anchor UE may also transmit additional system parameters, such as a reverse-link grant (e.g., scheduling information), to the client UE. The additional system parameters may be transmitted in the form of a block (e.g., that aggregates a plurality of reverse-link grants to a corresponding plurality of client UEs) included within sidelink control information (SCI), as described in greater detail below.

Further, in some aspects, the anchor UE 115 may provision for sidelink communications that allow the anchor UE 115 to communicate with a client UE 115, as well as a first client UE 115 to communicate with a second client US 115, without tunneling through a BS 105 and/or the core network. A pair of UEs, such as an anchor UE 115 and a client UE or a pair of client UEs 115, may communicate with each other over a sidelink in a forward link direction and a reverse link direction. The anchor US 115 may support reverse sidelink communication where the anchor UE 115 (e.g., receiving UE) may initiate a sidelink transmission, for example, by transmitting a reverse-link grant to a client UE 115 (e.g., transmitting UE). Responsive to receiving the reverse-link grant, the client UE 115 may transmit sidelink data to the anchor UE based at least in part on information included in the reverse-link grant, such as scheduling information. In this regard, a receiving UE is understood to be a UE that receives data (e.g., over PSSCH) from another UE in a sidelink communication, while a transmitting UE is understood to be a UE that transmits data (e.g., over PSSCH) to another UE in a sidelink communication. Over time, a single UE may be both a receiving UE and a transmitting UE. For example, in an initial sidelink communication a UE may be a receiving UE and in a later sidelink communication the same UE may be a transmitting UE, or vice versa.

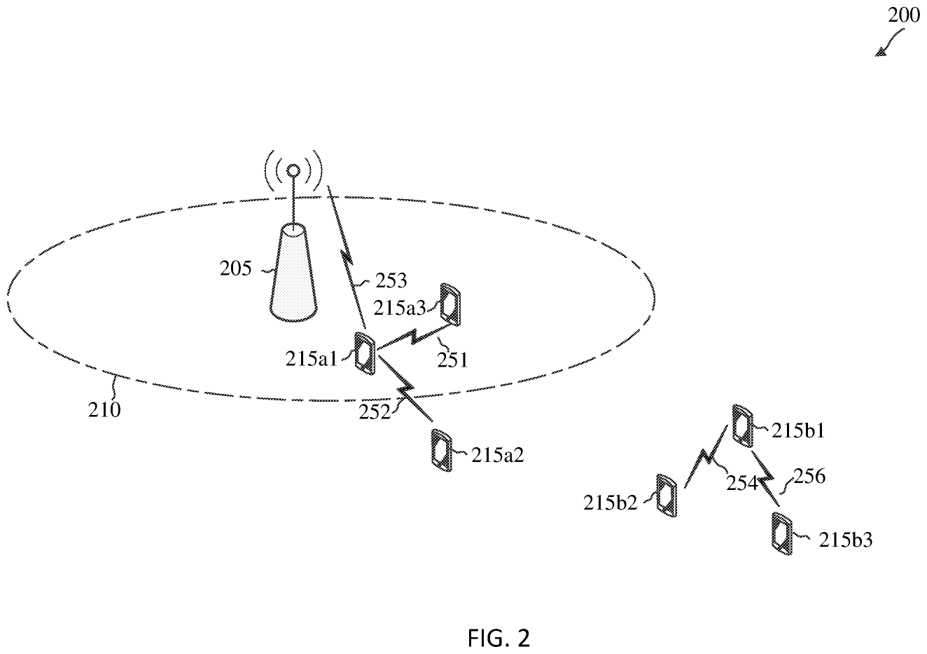

FIG. 2 illustrates an example of a wireless communication network 200 that provisions for sidelink communications according to embodiments of the present disclosure. The network 200 may correspond to at least a portion of the network 100. FIG. 2 illustrates a BS 205 and six UEs 215 (shown as 215a1, 215a2, 215a3, 215b1, 215b2, and 215b3) for purposes of simplicity of discussion, though it will be recognized that embodiments of the present disclosure may scale to any suitable number of UEs 215 and/or BSs 205. The BS 205 and the UEs 215 may be similar to the BSs 105 and the UEs 115, respectively. The BSs 205 and the UEs 215 may share the same radio frequency band (or at least a sub-band thereof) for communications. In some instances, the radio frequency band may be a 2.4 GHz unlicensed band, a 5 GHz unlicensed band, or a 6 GHz unlicensed band (or some other band, such as FR2). In general, the shared radio frequency band may be at any suitable frequency.

The BS 205 and the UEs 215a1-215a3 may be operated by a first network operating entity. The UEs 215b1-215b3 may be operated by a second network operating entity. In some aspects, the first network operating entity may utilize a same RAT as the second network operating entity. For instance, the BS 205 and the UEs 215a1-215a3 of the first network operating entity and the UEs 215b1-215b3 of the second network operating entity are NR-U devices. In some other aspects, the first network operating entity may utilize a different RAT than the second network operating entity. For instance, the BS 205a and the UEs 215a1-215a3 of the first network operating entity may utilize NR-U technology while the UEs 215b1-215b3 of the second network operating entity may utilize WiFi or LAA technology.

In the network 200, some of the UEs 215a1-215a3 and/or UEs 215b1-215b3 may communicate with each other in peer-to-peer communications. For example, the UE 215a1 may communicate with the UE 215a2 over a sidelink 252, the UE 215a1 may communicate with the UE 215a3 over another sidelink 251, the UE 215b1 may communicate with the UE 215b2 over yet another sidelink 254, and the UE 215b1 may communicate with the UE 215b3 over sidelink 256. The sidelinks 251, 252, 254, and 256 may be unicast bidirectional links. Some of the UEs 215 may also communicate with the BS 205 in a UL direction and/or a DL direction via communication links 253. For instance, the UE 215a1 and 215a3 are within a coverage area 210 of the BS 205, and thus may be in communication with the BS 205. The UE 215a2 is outside the coverage area 210, and thus may not be in direct communication with the BS 205. In some instances, the UE 215a1 may operate as a relay for the UE 215a2 to reach the BS 205. As an example, some of the UEs 215 may be associated with vehicles (e.g., similar to the UEs 115i-k) and the communications over the sidelinks 251, 252, 254, and 256 may be C-V2X communications. C-V2X communications may refer to communications between vehicles and any other wireless communication devices in a cellular network. This is exemplary only, as the sidelinks may be between any of a variety of different UE types and communications.

Further, as discussed above, the network 200 may support stand-alone sidelink communication among the UEs 215 over a shared radio frequency band, in which a subset of the UEs 215 are adapted as anchor nodes (e.g., anchor UEs) and autonomously initiate sidelink operation for the UEs 215. In this respect, the sidelink anchor UEs are autonomous and can perform sidelink operations independent of any cell, such as BS 205. There may be several scenarios where there may be a use for a UE 215 to become an anchor UE to perform sidelink-specific operations: (i) in multi-cell in-coverage, where a client UE (e.g., receiving UE) resides in a different asynchronous cell with respect to the sidelink transmitting UE; (ii) in partial-coverage, where the client UE, such as UE 215a2, is out of coverage and may need to acquire synchronization from the in-coverage sidelink transmitting UE, such as UE 215a1; and/or (iii) out of coverage, where both sidelink UEs, such as UE 215b1 and UE 215b2, are outside the coverage of a cell and the sidelink transmitting UE (e.g., UE 215b1) decides to act as a reference synchronization source (referred to as the anchor UE).

In any case, an anchor UE, such as 215a1 and 215b1, may transmit system parameter information so that client UEs, such as 215a2-3 and 215b2-3, respectively, may receive and recover resource allocation and timing information to facilitate sidelink communication with the anchor UE. Moreover, as described in greater detail below, the anchor UE may transmit one or more reverse-link grants aggregated into a subchannel so that the client UEs may initiate a sidelink transmission with the anchor UE based on information included in the reverse-link grants.

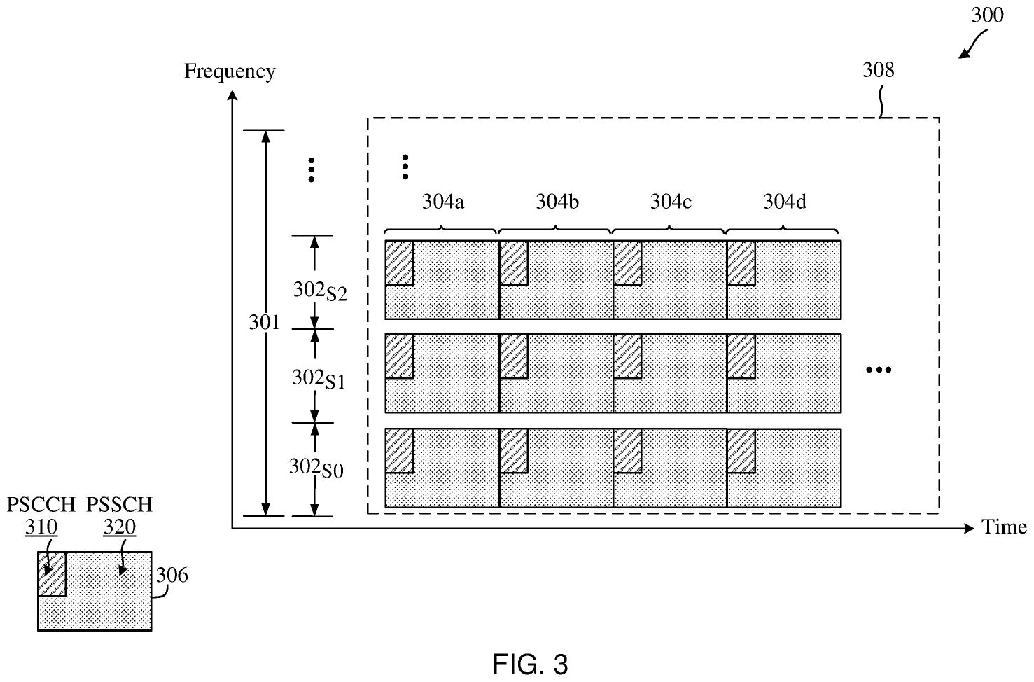

FIG. 3 illustrates a sidelink communication scheme 300 according to some aspects of the present disclosure. The scheme 300 may be employed by UEs such as the UEs 115 and/or 215 in a network such as the networks 100 and/or 200. In particular, sidelink UEs may employ the scheme 300 to engage in sidelink communications over a shared radio frequency band (e.g., in a shared spectrum or an unlicensed spectrum). In FIG. 3, the x-axis represents time in some arbitrary units, and the y-axis represents frequency in some arbitrary units.

In the scheme 300, a shared radio frequency band 301 is partitioned into a plurality of subchannels or frequency subbands 302 (shown as 302_{S0}, 302_{S1}, 302_{S2}, . . . ) in frequency and a plurality of sidelink slots or frames 304 (shown as 304a, 304b, 304c, 304d, . . . ) in time for sidelink communication. The frequency band 301 may be at any suitable frequencies (e.g., at about 2.4 GHz, 5 GHz, or 6 GHz, mmW ranges, etc.). The frequency band 301 may have any suitable BW and may be partitioned into any suitable number of frequency subbands 302. The number of frequency subbands 302 can be dependent on the sidelink communication BW requirement. In one example, the frequency band 301 is a 2.4 GHz unlicensed band and may have a bandwidth of about 80 megahertz (MHz) partitioned into about fifteen 5 MHz frequency subbands 302.

A sidelink UE (e.g., the UEs 115 and/or 215) may be equipped with a wideband receiver and a narrowband transmitter. For instance, the UE may utilize the narrowband transmitter to access a frequency subband 302s2 for sidelink transmission utilizing a frame structure 304. The frame structure 304 may be repeated in each frequency subband 302. In some instances, there can be a frequency gap or guard band between adjacent frequency subbands 302 as shown in FIG. 3, for example, to mitigate adjacent band interference. Thus, multiple sidelink data may be communicated simultaneously in different frequency subbands 302 (e.g., FDM). The frame structure 304 may also be repeated in time. For instance, the frequency subband 302s2 may be time-partitioned into a plurality of frames with the frame structure 304.

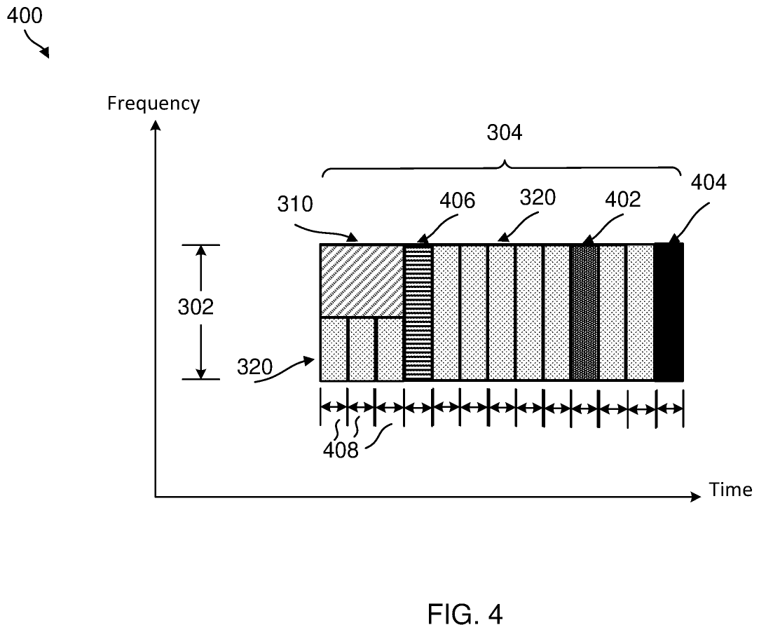

The frame structure 304 includes a sidelink resource 306 in each frequency subband 302. A legend 305 indicates some of the types of sidelink channels within a sidelink resource 306. The sidelink resource 306 may have a substantially similar structure as an NR sidelink resource. For instance, the sidelink resource 306 may include a number of resource elements (REs), which may include a number of subcarriers in frequency and a number of symbols in time. In some instances, the sidelink resource 306 may have a duration between about one millisecond (ms) to about 20 ms. Each sidelink resource 306 may include a PSCCH 310 and a PSSCH 320. The PSCCH 310 and the PSSCH 320 can be multiplexed in time and/or frequency. In the illustrated example of FIG. 3, for each sidelink resource 306, the PSCCH 310 is located during the beginning symbol(s) (e.g., about 1 symbol or about 2 symbols) of the sidelink resource 306 and occupies a portion of a corresponding frequency subband 302, and the PSSCH 320 occupies the remaining time-frequency resources in the sidelink resource 306. Further, as illustrated, the PSCCH 310 may not occupy all of the frequency band/subband, but rather a portion. This means that the PSSCH 320 may occupy a portion of the frequency band/subband as well in one or more of the first symbols of the time frame (such as a slot). In some instances, a sidelink resource 306 may also include a physical sidelink feedback channel (PSFCH), for example, located during the ending symbol(s) of the sidelink resource 306, as illustrated in FIG. 4. In general, a PSCCH 310, a PSSCH 320, and/or a PSFCH may be multiplexed in any suitable configuration within a sidelink resource 306.

In some aspects, the scheme 300 is used for synchronous sidelink communication. In other words, the sidelink UEs are synchronized in time and are aligned in terms of symbol boundary, sidelink resource boundary (e.g., the starting time of sidelink frames 304). The sidelink UEs may perform synchronization in a variety of forms, for example, based on sidelink SSBs received from a sidelink UE and/or NR-U SSBs received from a BS (e.g., the BSs 105 and/or 205) while in-coverage of the BS. In some aspects, the sidelink UE may be preconfigured with the resource pool 308 in the frequency band 301, for example. The resource pool 308 may include a plurality of sidelink resources 306.

As discussed above, the subject technology provides for a sidelink UE configured as a sidelink anchor UE (e.g., 115j, 215a1, 215b1) for configuring resource allocations to other client UEs. As such, the sidelink anchor UE can configure the client UE with a resource pool configuration indicating resources in the frequency band 301 and/or the subbands 302 and/or timing information associated with the sidelink frames 304. For instance, the sidelink anchor UE can provide resource allocation information to client UEs. In some aspects, the sidelink anchor UE can communicate a transmit resource pool configuration in the RMSI, in which the transmit resource pool configuration indicates which radio resources are allocated to the sidelink anchor UE for the sidelink anchor UE to transmit a sidelink communication. In some aspects, the sidelink anchor UE can communicate a receive resource pool configuration in the RMSI, in which the receive resource pool configuration indicates which radio resources are allocated to the sidelink anchor UE for the sidelink anchor UE to receive a sidelink communication (e.g., via a reverse link). In this respect, client UEs can receive and decode the physical communication channels (e.g., PSCCH 310, PSSCH 320) from the sidelink anchor UE based on the transmit resource pool configuration, and encode and transmit the PSCCH 310 and PSSCH 320 to the sidelink anchor UE based on the receive resource pool configuration.

FIG. 4 is a simplified block diagram of an exemplary sidelink resource slot 400, which may be used to transmit one or more reverse-link grants, according to some aspects of the present disclosure. The sidelink resource slot 400 includes a PSCCH 310, a PSSCH 320, a physical sidelink feedback channel (PSFCH) 402, a symbol gap 404 (e.g., a time gap), and a DMRS 406, in order to illustrate aspects of the present disclosure. Moreover, FIG. 4 illustrates the symbols 408 in time of the sidelink resource slot 400. Not all of the depicted sidelink resource channels and/or fields may be required, however, and one or more implementations may include additional channels and/or fields not shown in the figure. Variations in the arrangement and type of the sidelink resource channels and/or fields may be made without departing from the scope of the claims as set forth herein. Additional, different, or fewer channel and/or fields may be provided.

In sidelink communication, in order for the client UEs (e.g., one or more of client UEs 215a2-3 and 215b2-3 illustrated in FIG. 2) to successfully parse and/or decode the PSCCH 310 and PSSCH 320, information describing the specific resources assigned by the sidelink anchor UE (e.g., one or more of anchor UEs 215a1 or 215b1 illustrated in FIG. 2) for transmission and the transmission configuration can be carried in sidelink control information, SCI. In this respect, control information for sidelink communication may be communicated in the form of SCI messages. The SCI may inform the client UEs about a resource reservation interval, a frequency location of initial transmission and retransmission, a time gap between initial transmission and retransmission, and modulation and coding scheme (MCS) used to modulate the data transmitted over the PSSCH 320, among other things.

In some embodiments, the SCI may include a frequency hopping flag field, a resource block assignment and hopping resource allocation field, a time resource pattern field, MCS field, a time advance field and/or a beta offset field, and a group destination identifier field. The SCI may include other additional fields that are suitable to support control signaling (such as for V2X, etc). The time resource pattern field may provide the time-domain resource allocation for the data channel (e.g., PSSCH 320), and in particular the potential symbols used for PSSCH transmission. The MCS field may provide the MCS used for the PSSCH 320, which may be autonomously selected by the sidelink anchor UE. The timing advance field and/or a beta offset field may provide a sidelink time adjustment. The group destination identifier field may indicate a group of client UEs that are potentially interested in the transmitted message from the sidelink anchor UE. This may be used by the client UE to ignore messages destined to other groups of client UEs. Moreover, in some embodiments, the SCI may include one or more reverse-link grants, which may provide scheduling information such that a respective client UE may transmit a sidelink communication to the anchor UE based at least in part on information included in the reverse-link grant, as described in greater detail below. In addition to including the one or more reverse-link grants themselves, the SCI may include one or more data fields configured to identify a number of reverse-link grants included in the SCI and/or a size of a block including the reverse-link grants, one or more identifiers respectively corresponding to each of the reverse-link grants, and one or more identifiers respectively corresponding to the client UEs associated with the reverse-link grants, among other fields.

In some aspects, the SCI may be processed with transport channel encoding to generate SCI message transport blocks, which are then followed with physical channel encoding to generate corresponding PSCCH blocks. The PSCCH blocks are carried on respective symbols for transmission. The client UE may receive one or more resource units over respective symbols to recover the control signaling information, and can extract the data channel allocation and transmission configuration. Further, as described above, the SCI may be transmitted in stages over the PSCCH 310 and the PSSCH 320.

For example, the PSCCH 310 can be used for carrying first stage SCI (SCI-1). The PSSCH 320 can be used for carrying second stage SCI (SCI-2) and/or a third stage SCI (SCI-3). In some embodiments, the SCI-2 and/or the SCI-3 carried on the PSSCH 320 may include the block of reverse-link grants intended for multiple client UEs, as described in greater detail below. The PSSCH 320 may additionally carry sidelink data (e.g., forward link data). According to some embodiments of the present disclosure, the SCI-1 may carry one or more flags and/or bits of information that indicate whether the PSSCH is carrying forward link data or not, which the client UE may use to determine whether the PSSCH will just have rate-matched SCI-2 and/or SCI-3 data or a combination of SCI-2 and/or SCI-3 data and forward link (sidelink) data. The sidelink data, where present, can be of various forms and types depending on the sidelink application. For instance, when the sidelink application is a V2X application, the sidelink data may carry V2X data (e.g., vehicle location information, traveling speed and/or direction, vehicle sensing measurements, etc.). Alternatively, when the sidelink application is an IIoT application, the sidelink data may carry IIoT data (e.g., sensor measurements, device measurements, temperature readings, etc.). The PSFCH 402 can be used for carrying feedback information, for example, HARQ ACK/NACK for sidelink data received in an earlier sidelink resource 306.

The SCI can also indicate scheduling information and/or a destination identifier (ID) identifying a target client UE for the next sidelink resource 306. This may be included in an SCI-2, for example. Upon detecting SCI in a sidelink resource 306, the sidelink UE may determine whether the sidelink UE is the target receiver based on the destination ID. If the sidelink UE is the target receiver, the sidelink UE may proceed to receive and decode the sidelink data indicated by the SCI. In some aspects, multiple sidelink UEs may simultaneously communicate sidelink data in a sidelink frame 304 in different frequency subband (e.g., via FDM). For instance, in the sidelink frame 304b, one pair of sidelink UEs may communicate sidelink data using a sidelink resource 306 in the frequency subband 302s2 while another pair of sidelink UEs may communicates sidelink data using a sidelink resource 306 in the frequency subband 302si.

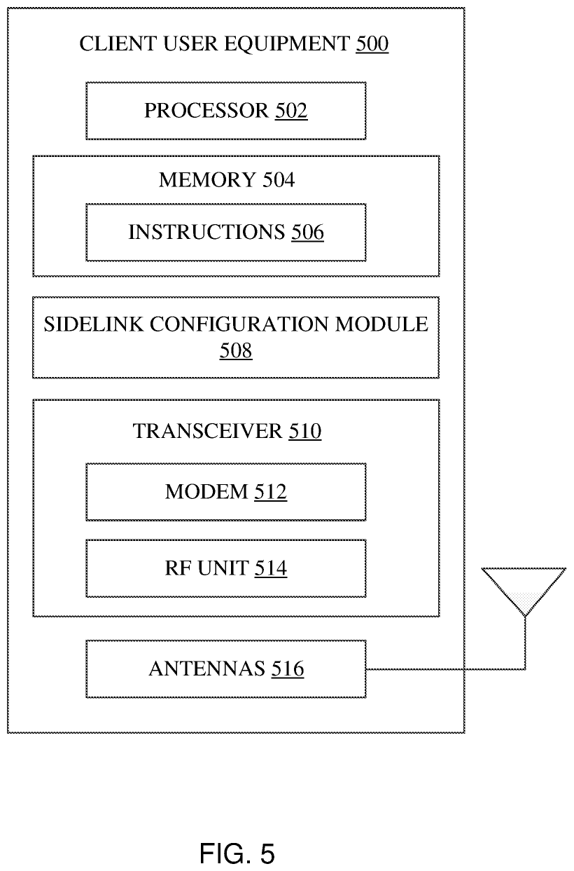

FIG. 5 is a block diagram of an exemplary client UE 500 (e.g., non-anchor UE) according to some aspects of the present disclosure. The client UE 500 may be a UE 115 in the network 100 as discussed above in FIG. 1 or a UE 215 discussed above in FIG. 2. As shown, the client UE 500 may include a processor 502, a memory 504, a sidelink communication module 508, a transceiver 510 including a modem subsystem 512 and a radio frequency (RF) unit 514, and one or more antennas 516. These elements may be in direct or indirect communication with each other, for example via one or more buses.

The processor 502 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 504 includes a non-transitory computer-readable medium. The memory 504 may store, or have recorded thereon, instructions 506. The instructions 506 may include instructions that, when executed by the processor 502, cause the processor 502 to perform the operations described herein with reference to the UEs 115 in connection with aspects of the present disclosure, for example, aspects of FIGS. 1-4, and 7-15. Instructions 506 may also be referred to as program code. The program code may be for causing a wireless communication device to perform these operations, for example by causing one or more processors (such as processor 502) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink communication module 508 may be implemented via hardware, software, or combinations thereof. For example, the sidelink communication module 508 may be implemented as a processor, circuit, and/or instructions 506 stored in the memory 504 and executed by the processor 502. In some instances, the sidelink communication module 508 can be integrated within the modem subsystem 512. For example, the sidelink communication module 508 can be implemented by a combination of software components (e.g., executed by a DSP or a general processor) and hardware components (e.g., logic gates and circuitry) within the modem subsystem 512.

The sidelink communication module 508 may be used for various aspects of the present disclosure, for example, aspects of FIGS. 1-4, and 7-15. In some aspects, the sidelink communication module 508 is adapted to monitor one or more SCI transmissions in order to receive a reverse-link grant from an anchor UE and, responsive to receiving the reverse-link grant, initiate sidelink communication with the anchor UE based in part on the reverse-link grant. According to embodiments of the present disclosure, this may include receiving an SCI-1 transmission from an anchor UE that indicates whether there is forward link data included in PSSCH together with SCI-2 and/or SCI-3 data (which includes reverse-link grants for multiple UEs including, potentially, the client UE 500, which may be indicated by an identifier of the client UE 500 for example), as well as the block of reverse-link grants in SCI-2 (in some embodiments), or in SCI-3 (in some embodiments). In embodiments where the block of reverse-link grants is included in SCI-3, SCI-2 may indicate the parameters for SCI-3 including block size, number of clients of the SCI-3, as well as potentially including an indication of forward link data or not (instead of SCI-1 in some embodiments). Details relating to SCI-1, SCI-2, and/or SCI-3 are included above and further below with respect to the remaining figures.

As shown, the transceiver 510 may include the modem subsystem 512 and the RF unit 514. The transceiver 510 can be configured to communicate bi-directionally with other devices, such as the BSs 105. The modem subsystem 512 may be configured to modulate and/or encode the data from the memory 504 and/or the sidelink communication module 508 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 514 may be configured to process (e.g., perform analog to digital conversion or digital to analog conversion, etc.) modulated/encoded data (e.g., SCI, sidelink data, synchronization signal, SSBs, uplink data, etc.) from the modem subsystem 512 (on outbound transmissions) or of transmissions originating from another source such as a UE 115 or a BS 105. The RF unit 514 may be further configured to perform analog beamforming in conjunction with the digital beamforming. Although shown as integrated together in transceiver 510, the modem subsystem 512 and the RF unit 514 may be separate devices that are coupled together at the UE 500 to enable the UE 500 to communicate with other devices.

The RF unit 514 may provide the modulated and/or processed data, e.g. data packets (or, more generally, data messages that may contain one or more data packets and other information), to the antennas 516 for transmission to one or more other devices. The RF unit 514 may process the modulated and/or processed data and generate corresponding time-domain waveforms using SC-FDMA modulation prior to transmission via the antennas 516. In other instances, the RF unit 514 may utilize OFDM modulation to generate the time-domain waveforms. The antennas 516 may further receive data messages transmitted from other devices. The antennas 516 may provide the received data messages for processing and/or demodulation at the transceiver 510. The transceiver 510 may provide the demodulated and decoded data (e.g., sidelink configuration, SCI, sidelink data, SCI reservation collision information, synchronization signal, SSBs) to the sidelink communication module 508 for processing. The antennas 516 may include multiple antennas of similar or different designs in order to sustain multiple transmission links. The RF unit 514 may configure the antennas 516. In some aspects, the RF unit 514 may include various RF components, such as local oscillator (LO), analog filters, and/or mixers. The LO and the mixers can be configured based on a certain channel center frequency. The analog filters may be configured to have a certain passband depending on a channel BW. The RF components may be configured to operate at various power modes (e.g., a normal power mode, a low-power mode, power-off mode) and may be switched among the different power modes depending on transmission and/or reception requirements at the client UE 500 and/or an anchor UE.

In an aspect, the client UE 500 can include multiple transceivers 510 implementing different RATs (e.g., NR and LTE). In an aspect, the client UE 500 can include a single transceiver 510 implementing multiple RATs (e.g., NR and LTE). In an aspect, the transceiver 510 can include various components, where different combinations of components can implement different RATs.

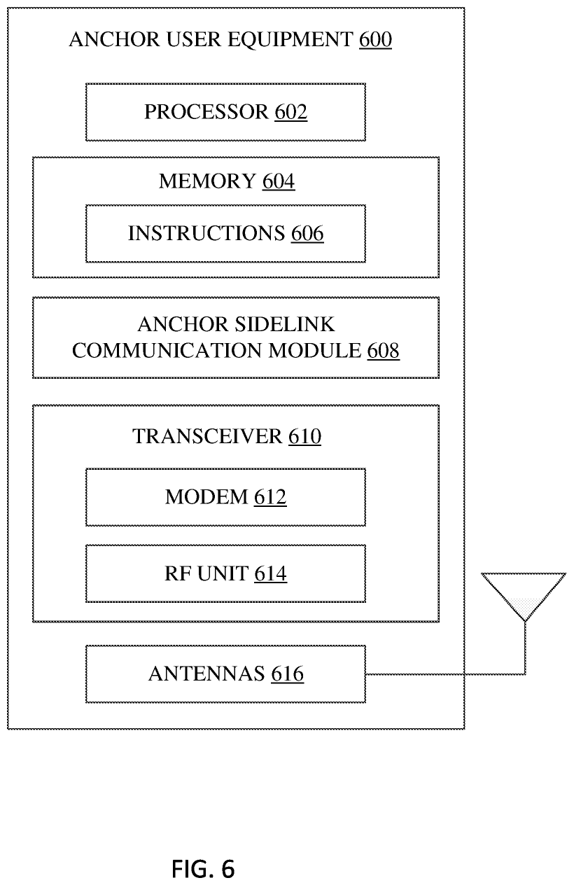

FIG. 6 is a block diagram of an exemplary anchor UE 600 according to some aspects of the present disclosure. The anchor UE 600 may be a UE 115 in the network 100 as discussed above in FIG. 1 or a UE 215 discussed above in FIG. 2. As shown, the anchor UE 600 may include a processor 602, a memory 604, an anchor sidelink configuration module 608, a transceiver 610 including a modem subsystem 612 and a RF unit 614, and one or more antennas 616. These elements may be in direct or indirect communication with each other, for example via one or more buses.

The processor 602 may have various features as a specific-type processor. For example, these may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 604 may include a non-transitory computer-readable medium. The memory 604 may store instructions 606. The instructions 606 may include instructions that, when executed by the processor 602, cause the processor 602 to perform operations described herein, for example, aspects of FIGS. 1-4, and 7-15. Instructions 606 may also be referred to as code, which may be interpreted broadly to include any type of computer-readable statement(s) as discussed above with respect to FIG. 5.

The anchor sidelink configuration module 608 may be implemented via hardware, software, or combinations thereof. For example, the anchor sidelink configuration module 608 may be implemented as a processor, circuit, and/or instructions 606 stored in the memory 604 and executed by the processor 602. In some instances, the anchor sidelink configuration module 608 can be integrated within the modem subsystem 612. For example, the anchor sidelink configuration module 608 can be implemented by a combination of software components (e.g., executed by a DSP or a general processor) and hardware components (e.g., logic gates and circuitry) within the modem subsystem 612.

The anchor sidelink configuration module 608 may be used for various aspects of the present disclosure, for example, aspects of FIGS. 1-4, and 7-15. For instance, the anchor sidelink configuration module 608 is configured to determine and transmit one or more reverse-link grants to one or more client UEs. According to embodiments of the present disclosure, this may include configuring an SCI-1 transmission that indicates whether there is forward link data included in PSSCH together with SCI-2 and/or SCI-3 data (which includes reverse-link grants for multiple client UEs). The anchor sidelink configuration module 608 may further determine the block of reverse-link grants to be transmitted in a given timeframe for one or more client UEs, and place those reverse-link grants into a block for transmission. The anchor sidelink communication module 608 may place this block of reverse-link grants in SCI-2 (in some embodiments), or in SCI-3 (in some embodiments). In embodiments where the block of reverse-link grants is included in SCI-3, the anchor sidelink communication module 608 may further include in SCI-2 an indication of the parameters for SCI-3 including block size, number of clients of the SCI-3, as well as potentially including an indication of forward link data or not (instead of SCI-1 in some embodiments). Details relating to SCI-1, SCI-2, and/or SCI-3 are included above and further below with respect to the remaining figures.

As shown, the transceiver 610 may include the modem subsystem 612 and the RF unit 614. The transceiver 610 can be configured to communicate bi-directionally with other devices, such as the UEs 115 and/or 600 and/or another core network element. The modem subsystem 612 may be configured to modulate and/or encode data according to a MCS, e.g., a LDPC coding scheme, a turbo coding scheme, a convolutional coding scheme, a polar coding scheme, a digital beamforming scheme, etc. The RF unit 614 may be configured to process (e.g., perform analog to digital conversion or digital to analog conversion, etc.) modulated/encoded data (e.g., PDCCH, PDSCH, SSBs, sidelink configuration, sidelink resource pool configuration, SSBs, frequency hopping patterns for sidelink communication, PSCCH, PSSCH, etc.) from the modem subsystem 612 (on outbound transmissions) or of transmissions originating from another source such as a UE 115 and/or BS 105. The RF unit 614 may be further configured to perform analog beamforming in conjunction with the digital beamforming. Although shown as integrated together in transceiver 610, the modem subsystem 612 and/or the RF unit 614 may be separate devices that are coupled together at the UE 600 to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The RF unit 614 may process the modulated and/or processed data and generate corresponding time-domain waveforms using SC-FDMA modulation prior to transmission via the antennas 616. In other instances, the RF unit 614 may utilize OFDM modulation to generate the time-domain waveforms. The antennas 616 may further receive data messages transmitted from other devices and provide the received data messages for processing and/or demodulation at the transceiver 610. The transceiver 610 may provide the demodulated and decoded data to the anchor sidelink configuration module 608 for processing. The antennas 616 may include multiple antennas of similar or different designs to sustain multiple transmission links.

In an aspect, the anchor UE 600 can include multiple transceivers 610 implementing different RATs (e.g., NR and LTE). In an aspect, the anchor UE 600 can include a single transceiver 610 implementing multiple RATs (e.g., NR and LTE). In an aspect, the transceiver 610 can include various components, where different combinations of components can implement different RATs.

Mechanisms for transmitting one or more reverse-link grants in the form of SCI (e.g., using SCI-1 via PSCCH, SCI-2 via PSSCH, and/or SCI-3 via PSSCH) are described in greater detail herein.

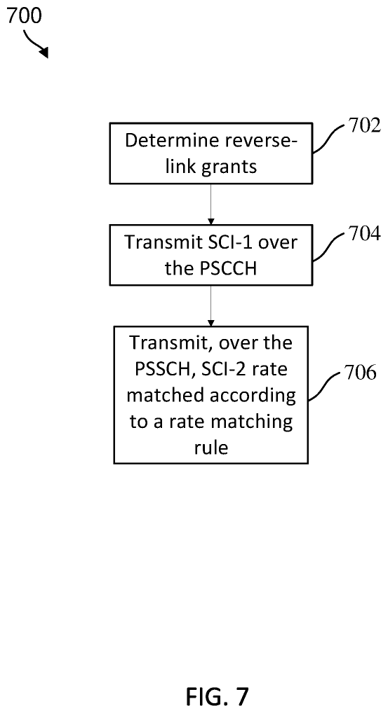

FIG. 7 is a flow diagram of a first reverse-link grant transmission process according to some aspects of the present disclosure. Aspects of the process 700 can be executed by a computing device (e.g., a processor, processing circuit, and/or other suitable component) of a wireless communication device or other suitable means for performing the steps. For example, a wireless communication device, such as the UEs 115, 215, and/or 600, may utilize one or more components, such as the processor 602, the memory 604, the anchor sidelink communication module 608, the transceiver 610, the modem 612, and the one or more antennas 616, to execute the steps of process 700. As illustrated, the process 700 includes a number of enumerated steps, but aspects of the process 700 may include additional steps before, after, and in between the enumerated steps. In some aspects, one or more of the enumerated steps may be omitted or performed in a different order.

At block 702, an anchor UE (e.g., UE 600) may determine one or more reverse-link grants for transmission, such as a plurality of reverse-link grants intended for a corresponding plurality of client UEs. In some aspects, the anchor UE 600 may determine the reverse-link grants based in part on scheduling conditions at the anchor UE 600. For example, anchor sidelink communication module 608 may be configured to determine the one or more reverse-link grants based on sidelink channel information (e.g., channel quality information (CQI) and/or channel sensing information). Additionally or alternatively, the anchor UE 600 may determine a reverse-link grant based at least in part on a transmission delay between a certain client UE 500 and the anchor UE 600. Each reverse-link grant may correspond to a particular client UE 500. Accordingly, the reverse-link grants may be configured to provide scheduling information such that the anchor UE 600 may successfully receive a corresponding transmission from a client UE 500 to the anchor UE 600.

At block 704, the anchor UE 600 may transmit first stage control information (SCI-1) over the PSCCH. The anchor UE 600 may transmit the SCI-1 using the transceiver 610, for example. The SCI-1 may include resource allocation information, as well as additional fields, as described above with reference to FIG. 4. Additionally, in some aspects, the SCI-1 may include information related to second stage control information (SCI-2). For example, the SCI-1 may include a size of the SCI-2 and information regarding parsing the SCI-2. Further, in some aspects, the SCI-1 may indicate whether the PSSCH includes sidelink data (e.g., user data and/or forward link data) or not, as described in greater detail below (e.g., such as with a dedicated flag for that purpose, etc.).

At block 706, the anchor UE 600 may transmit, over the PSSCH 320, the SCI-2 rate matched according to a rate matching rule. As described herein, the term “rate matching” may refer to a process of sizing and/or modulating data to fit into a particular block of time-frequency elements (such as available resource elements for PSSCH within a time frame, such as a slot, according to embodiments of the present disclosure). In some aspects, the SCI-2 includes the reverse-link grants determined at block 702. Further, after determining the reverse-link grants, the anchor UE 600 may aggregate the reverse-link grants into a block. Accordingly, the SCI-2 may include the reverse-link grants in a single data block. The SCI-2 may also include information for decoding the PSSCH 320. For example, the SCI-2 may include a destination identifier that identifies a corresponding client UE 500, and the SCI-2 may include a source identifier that identifies the anchor UE 600. In any case, the SCI-2 may be rate matched according to the rate matching rule such that the SCI-2 occupies particular resource elements and/or symbols of the PSSCH 320. For example, where the DMRS in the PSSCH is not transmitted at the start of PSSCH in a given slot, the anchor UE 600 may rate match the SCI-2 from the beginning of the PSSCH (and around the DMRS). As another example (with DMRS not transmitted at the start of PSSCH), the anchor UE 600 may rate match the SCI-2 from the beginning of the DMRS, and upon reaching the end of the slot, go back to the beginning of the PSSCH within the slot. These examples, and others, are discussed with more detail related to other figures further below.

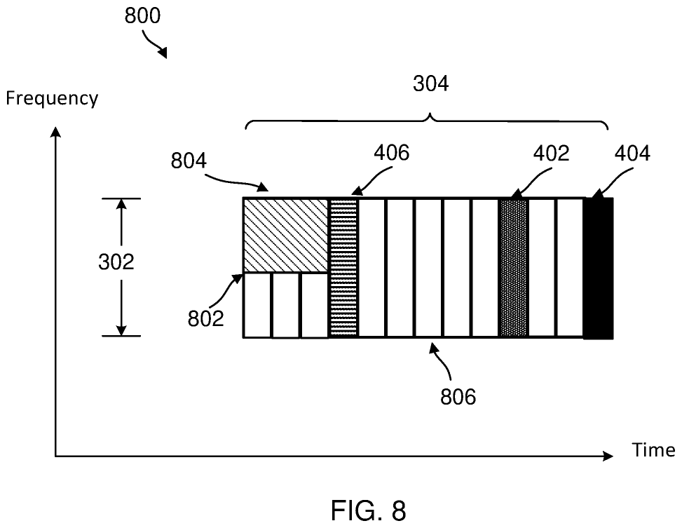

For example, turning now to FIG. 8, in some embodiments (where the DMRS does not begin at the start of the PSSCH) the SCI-2 transmitted over the PSSCH 806 may be rate matched according to a first rate matching rule. According to the first rate matching rule, the SCI-2 may be rate matched from a start 802 of the PSSCH 806. As used herein, the term “start of the PSSCH,” the term “a first resource element of the PSSCH,” and the term “the first resource element after the PSCCH” can refer to a first time-frequency resource (e.g., a combination of a subcarrier and a symbol) of the PSSCH, and may be interchangeable.

Further, as illustrated by the block diagram of exemplary first sidelink resources 800 having one or more reverse-link grants, the SCI-2 may be rate matched to occupy any resource element available (e.g., unoccupied) following the start 802 of the PSSCH 806. To that end, the SCI-2 may be rate matched to occupy contiguous resource elements from the start 802 to an end of the PSSCH 806. Additionally, the rate-matched SCI-2 may overlap the DMRS 406 (e.g., be interspersed therewith). Thus, in some embodiments, the SCI-2 may be rate matched according to the first rate matching rule when the PSSCH 806 lacks user data and the DMRS 406 is transmitted after a first resource element of the PSSCH 320.

Moreover, because no user data is included on the PSSCH 320, the transmission of the sidelink resources 800 may be dedicated to information associated with the reverse-link grants included in the SCI-2. To that end, the anchor UE 600 may transmit each portion of the sidelink resources 800 (e.g., the SCI-1 on PSCCH 804, the SCI-2 on PSSCH 806, etc.) regardless of whether the anchor UE 600 has forward link data to transmit to a particular client UE 500. Further, in some embodiments, the SCI-1 may include an additional data field configured to indicate whether the PSSCH 806 includes user data (i.e., forward link data) or not. Thus, as described in greater detail below, the SCI-1 on PSCCH 804 may indicate whether the transmission of the sidelink resources 800 is dedicated to information associated with reverse-link grants or includes user data as well.

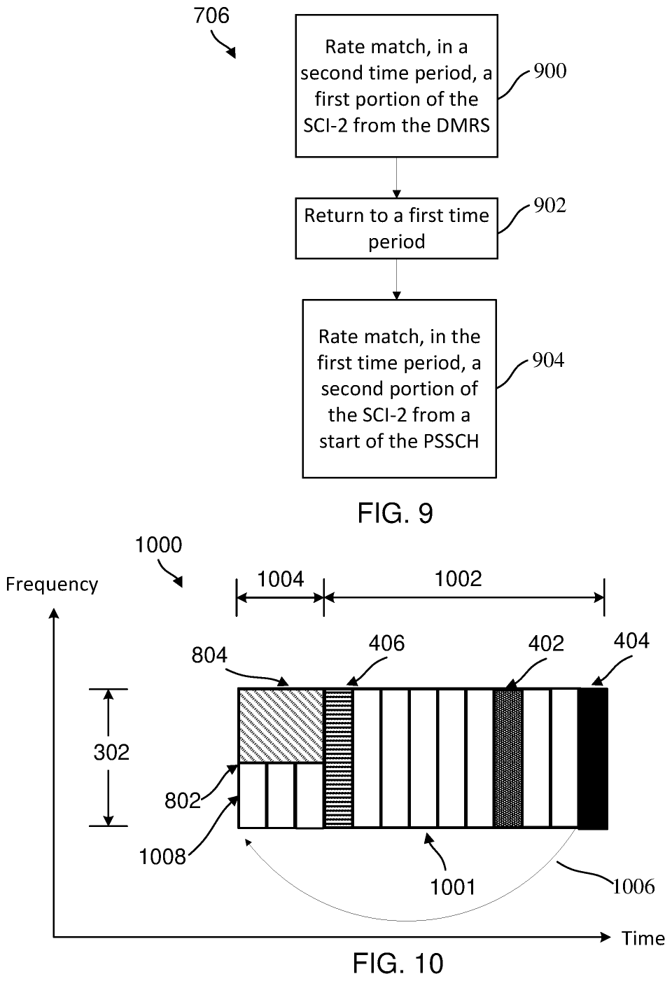

FIG. 9 is a flow diagram of an exemplary embodiment for transmitting the SCI-2 according to a rate matching rule. More specifically, FIG. 9 illustrates an embodiment performing block 706 according to a second rate matching rule. Accordingly, consistent with the description above, the aspects involved in performing block 706 may be executed by a computing device (e.g., a processor, processing circuit, and/or other suitable component) of a wireless communication device or other suitable means for performing the steps. For example, a wireless communication device, such as the UEs 115, 215, and/or 600, may utilize one or more components, such as the processor 602, the memory 604, the anchor sidelink communication module 608, the transceiver 610, the modem 612, and the one or more antennas 616, to execute the aspects of block 706. As illustrated, block 706 includes a number of enumerated steps, but aspects of block 706 may include additional steps before, after, and in between the enumerated steps. In some aspects, one or more of the enumerated steps may be omitted or performed in a different order.

With reference now to block 900 and the exemplary sidelink resources 1000 illustrated in FIG. 10, the anchor UE 600 may rate match, in a second time period 1002 (e.g., a second set of symbols 408) of the PSSCH 320, a first portion of the SCI-2 1001. The second time period 1002 may start, for example, with the start of the DMRS 406.

As illustrated in FIG. 10, in some embodiments the anchor UE 600 may transmit the SCI-1 in PSCCH 804 in a first time period 1004. As illustrated, the first time period 1004 occurs in time before the second time period 1002. Following the first time period 1004, the anchor UE 600 may transmit the DMRS 406 in the second time period 1002 and begin rate matching the first portion of the SCI-2 1001 from the start of the DMRS 406. In some embodiments, the anchor UE 600 is configured to use the second matching rule when the PSSCH lacks user data and the DMRS 406 is transmitted after a first resource element of the PSSCH (e.g., after the start of the PSSCH 802).

At block 902 of FIG. 9, the anchor UE 600 may, while rate matching the SCI-2 in the PSSCH, return to the first time period 1004, as indicated by arrow 1006 of FIG. 10. In such embodiments, the resource elements of the PSSCH—including the start 802 of the PSSCH—within the first time period 1004 may be available (e.g., unoccupied and/or not reserved). To that end, the anchor UE 600 may be configured to return to the start 802 of the PSSCH while in the process of rate matching the SCI-2 according to the second rate matching rule.

At block 904 of FIG. 9, the anchor UE 600 may rate match, in the first time period 1004, the second portion 1008 of the SCI-2 from the start 802 of the PSSCH (e.g., a first resource element after the PSCCH) to fill the resource elements of the PSSCH within the first time period 1004 with a second portion 1008 of the SCI-2 (e.g., a remaining portion of the SCI-2). In some embodiments, the anchor UE 600 may rate match the second portion 1008 of the SCI-2 from the start of the PSSCH 802 to the start of the DMRS signal 406 at the second time period 1002. Thus, in some embodiments, the anchor UE 600 may rate match the second portion 1008 of the SCI-2 as part of the general rate matching of the SCI-2 overall such that the second portion 1008 of the SCI-2 occupies the available resource elements of the PSSCH positioned within the first time period 1004.

As can be seen from the above discussion and with reference to FIG. 10, the first portion 1001 of the SCI-2 may include data, such as a first portion of the block of reverse-link grants, configured to be decoded and/or parsed before progressing to the remaining portion of the reverse-link grants included in the second portion 1008 of the SCI-2. That is, for example, although the data in the second portion 1008 of the SCI-2 may be transmitted at an earlier time, the data in the first portion 1001 of the SCI-2 may be read and/or decoded, by a client UE 500, chronologically before the data in the second portion 1008 of the SCI-2, and thus held until the full SCI-2 is available at the client UE 500 for further processing.

Moreover, because in this example no user data is included on the PSSCH, the transmission of the sidelink resources 1000 may be dedicated to information associated with the reverse-link grants included in the SCI-2. To that end, the anchor UE 600 may transmit each portion of the sidelink resources 1000 (e.g., the SCI-1, the SCI-2) regardless of whether forward link transmission is occurring on a sidelink (e.g., 251, 252, 254, 256) and/or to a particular client UE 500 (thus reducing delay, for example).

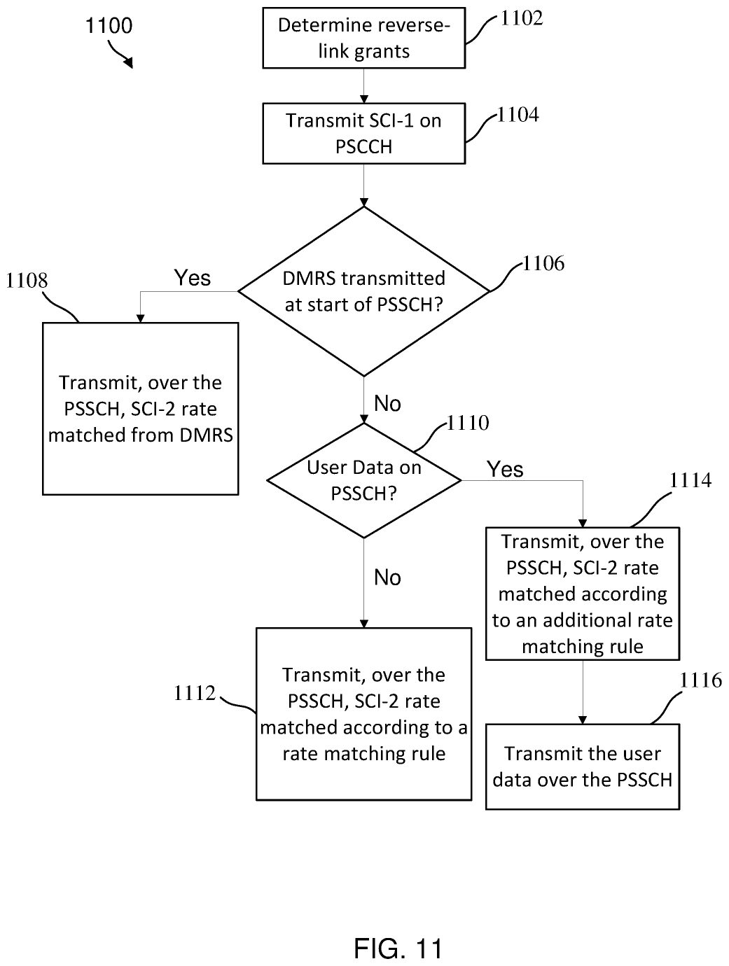

FIG. 11 is a flow diagram of a second reverse-link grant transmission process 1100 according to some aspects of the present disclosure. Aspects of the process 1100 can be executed by a computing device (e.g., a processor, processing circuit, and/or other suitable component) of a wireless communication device or other suitable means for performing the steps. For example, a wireless communication device, such as the UEs 115, 215, and/or 600, may utilize one or more components, such as the processor 602, the memory 604, the anchor sidelink communication module 608, the transceiver 610, the modem 612, and the one or more antennas 616, to execute the steps of process 1100. The process 1100 may employ, at least in part, similar mechanisms as in the process 700 discussed above with respect to FIG. 7. As illustrated, the process 1100 includes a number of enumerated steps, but aspects of the process 1100 may include additional steps before, after, and in between the enumerated steps. In some aspects, one or more of the enumerated steps may be omitted or performed in a different order.

At block 1102, the anchor UE 600 may determine one or more reverse-link grants. As described above with reference to process 700, the anchor UE 600 may determine the reverse-link grants based in part on scheduling conditions at the anchor UE 600. For example, anchor sidelink communication module 608 may be configured to determine the one or more reverse-link grants based on sidelink channel information (e.g., CQI and/or channel sensing information). Additionally or alternatively, the anchor UE 600 may determine reverse-link grants based at least in part on a transmission delay between a given client UE 500 and the anchor UE 600. Each reverse-link grant may correspond to a particular client UE 500. Accordingly, the reverse-link grants may be configured to provide scheduling information such that the anchor UE 600 may successfully receive a corresponding transmission from a client UE 500 to the anchor UE 600.

At block 1104, the anchor UE may transmit the SCI-1 over PSCCH. In some embodiments, the SCI-1 may include a data field (e.g., a flag and/or a bit, either modified from another data field or a new data field) configured to indicate whether the PSSCH (e.g., sidelink resources 400, 800, 1000 illustrated in the figures) includes user data (e.g., sidelink data and/or forward link data). For example, the data field may be set to a first state to indicate a lack of user data on the PSSCH, and the data field may be set to a different second state to indicate the presence of user data on the PSSCH. Moreover, the SCI-1 may include any suitable data fields, such as a data field configured to indicate a size of the SCI-2, a data field configured to indicate resource allocation, and/or the data fields described above with reference to FIG. 4, among other fields.

At decision block 1106, the anchor UE 600 may determine whether a DMRS 406 is transmitted on the PSSCH at the start of the PSSCH (e.g., start 802 in FIG. 8 or 10), or later in the PSSCH. In some embodiments, the anchor UE 600 may be preconfigured to transmit the DMRS 406 at start 802 of the PSSCH, while in other embodiments the anchor UE 600 may be preconfigured to transmit the DMRS 406 or after a space of time (on the order of a few symbols, for example), such as illustrated with the first time period 1004 in FIG. 10. In such embodiments, the anchor UE 600 may determine whether the DMRS 406 is transmitted at the start 802 of the PSSCH based at least in part on the preconfigured settings of the anchor UE 600, for example. Additionally or alternatively, the anchor UE 600 may determine whether the DMRS 406 is transmitted at the start 802 of the PSSCH based in part on sidelink channel information.

Responsive to determining the DMRS 406 is transmitted at the start of the PSSCH 802, the process 1100 may proceed to block 1108. At block 1108, the anchor UE 600 may transmit, over the PSSCH, the SCI-2 rate matched from the DMRS 406. In some embodiments, determining the DMRS 406 is transmitted at the start 802 of the PSSCH may involve determining that the DMRS 406 is transmitted in a first symbol on the PSSCH. Accordingly, rate matching the SCI-2 from the DMRS 406 may involve rate matching the SCI-2 from the first symbol of the PSSCH such that the SCI-2 occupies any available resource elements on the PSSCH beginning from the first symbol of the PSSCH. If the PSSCH lacks user data (e.g., as indicated by a flag set in SCI-1), rate matching the SCI-2 from the DMRS 406 may involve rate matching the SCI-2 to each remaining resource element on the PSSCH. On the other hand, if the PSSCH includes user data (e.g., as indicated by a flag in SCI-1), one set of the resource elements of the PSSCH may be reserved for the user data, and the SCI-2 may be rate matched from the DMRS 406 to a different set of the resource elements that are not reserved for the user data.

Returning to decision block 1106, if instead the anchor UE 600 determines that the DMRS 406 is not transmitted at the start 802 of the PSSCH, the process 1100 may proceed to decision block 1110.

At decision block 1110, the anchor UE 600 determine whether the PSSCH includes user data (e.g., the anchor UE 600 may determine whether it has any user data to transmit via forward link in the PSSCH in that slot). If it is determined at decision block 1110 that there is no user data to transmit in the forward link with the SCI-2, then the process 1100 proceeds to block 1112.

At block 1112, the anchor UE 600 may transmit the SCI-2 over the PSSCH. More specifically, the anchor UE 600 may transmit, over the PSSCH, the SCI-2 rate matched according to a rate matching rule, as described above with reference to the first and second rate matching rules (as examples). To that end, the anchor UE 600 may rate match the SCI-2 from the start 802 of the PSSCH and continue to rate match the SCI-2 to any available resource elements on the PSSCH to the end of the slot (for example). Alternatively, the anchor UE 600 may (with reference to the example illustrated in FIG. 10), in the second time period 1002, rate match the first portion 1001 of the SCI-2 from the DMRS 406, return to the first time period 1004, and, in the first time period 1004, rate match the second portion 1008 of the SCI-2 from the first resource element after the PSCCH.

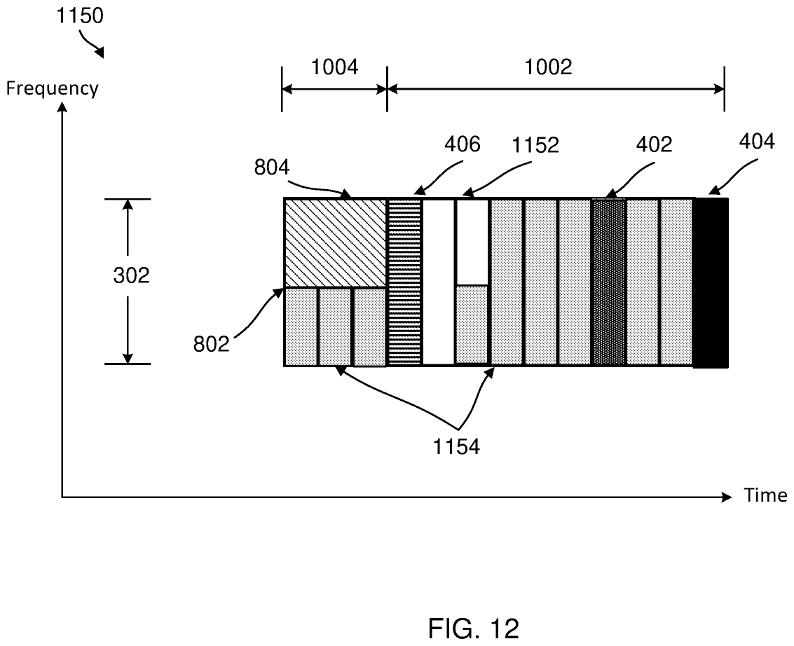

Returning to decision block 1110, if instead the anchor UE 600 determines that the PSSCH includes user data, the process 1100 may proceed to block 1114 instead. At block 1114, the anchor UE 600 may transmit the SCI-2 over the PSSCH according to an additional rate matching rule. In some instances, rate matching the SCI-2 according to the additional rate matching rule may involve rate matching the SCI-2 from a start of the DMRS 406, as illustrated in FIG. 12 and discussed further below.

At block 1116, the anchor UE 600 may transmit the user data identified at block 1110 over the PSSCH. As described in greater detail below, the transmitting the user data may involve transmitting the user data within the first time period 1004 (FIG. 12) and the second time period 1002 (FIG. 12), with the SCI-2 data included from the DRMS 406 as SCI-2 1152 in FIG. 12.

Turning now to FIG. 12, an exemplary block diagram of sidelink resources 1150 is provided. As shown, the sidelink resources 1150 include user data 1154 and SCI-2 1152 rate matched according to the additional rule (e.g., block 1114 of FIG. 11).

In some embodiments, the sidelink resources 1150 include a first portion of the user data 1154 within the first time period 1004. To that end and with reference to block 1116 of FIG. 11, the anchor UE 600 may transmit the first portion of the user data 1154 within the first time period 1004. Moreover, the anchor UE 600 may transmit a second portion of the user data 1154 within the second time period 1002 such that the sidelink resource 1150 includes user data 1154 within the second time period 1002.

With user data 1154 present in the second time period 1002 of the PSSCH, the SCI-2 1152 may be rate matched, according to the additional rate matching rule, to occupy a set of resource elements of the PSSCH that are unoccupied and/or not reserved for the user data 1154 within the second time period 1002 (e.g., at the start of the DMRS 406). Accordingly, the SCI-2 1152 may be rate matched to a subset of the resource elements following the DMRS 406, as illustrated in FIG. 12.

Accordingly, as illustrated and discussed above, the reverse-link grants may be transmitted as a block to multiple client UEs 500 as part of SCI-2, with assistance from SCI-1 (e.g., to indicate whether there is user data present in the slot). In other embodiments, the anchor UE 600 may be configured to transmit the reverse-link grants using third stage control information (SCI-3). In such embodiments, the SCI-1 may include information associated with the SCI-2 (e.g., without any changes such as additional or modified data fields), the SCI-2 may include information associated with the SCI-3 (e.g., including new information such as in one or more new data fields about the new SCI-3), and the SCI-3 may include the reverse-link grants, as described in greater detail below.

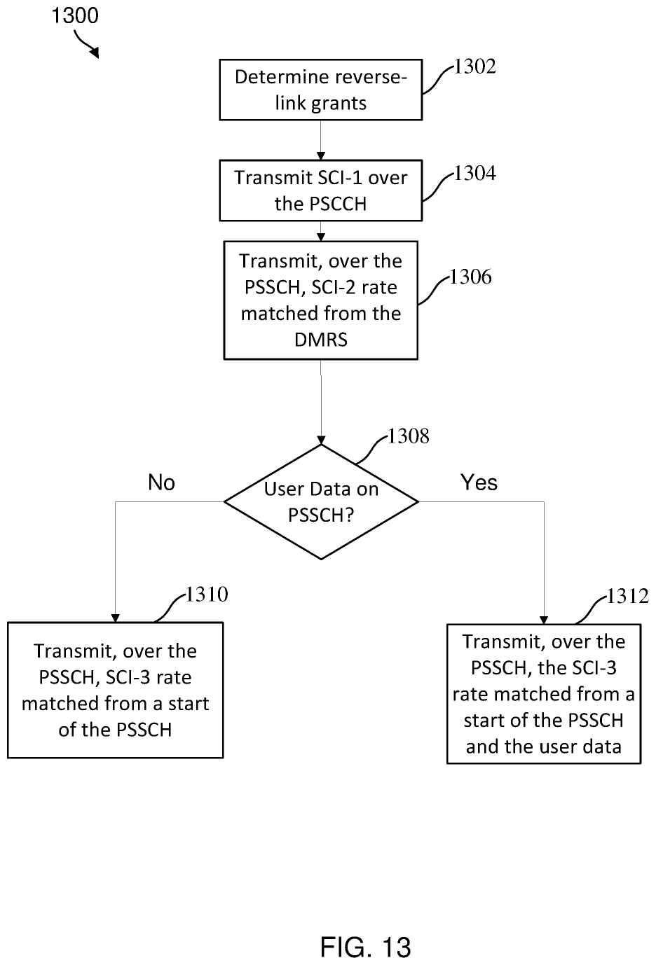

FIG. 13 is a flow diagram of a third reverse-link grant transmission process 1300 that utilizes SCI-3 according to some aspects of the present disclosure. Aspects of the process 1300 can be executed by a computing device (e.g., a processor, processing circuit, and/or other suitable component) of a wireless communication device or other suitable means for performing the steps. For example, a wireless communication device, such as the UEs 115, 215, and/or 600, may utilize one or more components, such as the processor 602, the memory 604, the anchor sidelink communication module 608, the transceiver 610, the modem 612, and the one or more antennas 616, to execute the steps of process 1300. The process 1300 may employ similar mechanisms as in the process 700 discussed above with respect to FIG. 7. As illustrated, the process 1300 includes a number of enumerated steps, but aspects of the process 1300 may include additional steps before, after, and in between the enumerated steps. In some aspects, one or more of the enumerated steps may be omitted or performed in a different order.

At block 1302, the anchor UE 600 may determine one or more reverse-link grants for transmission. In some aspects, the anchor UE 600 may determine the reverse-link grants based in part on scheduling conditions at the anchor UE 600, as described above with reference to FIG. 7. Moreover, each reverse-link grant may correspond to a particular client UE 500. Accordingly, the reverse-link grants may be configured to provide scheduling information such that the anchor UE 600 may successfully receive a corresponding transmission from a client UE 500 to the anchor UE 600. Further, in some embodiments, the anchor UE 600 may aggregate the one or more reverse-link grants into a single block for transmission (e.g., in SCI-3 according to embodiments of FIG. 13).

At block 1304, the anchor UE 600 may transmit the SCI-1 over the PSSCH. In some aspects, the SCI-1 may include data associated with SCI-2, such as the size of the SCI-2. Further, in some embodiments, the data fields included in the SCI-1 may remain unchanged compared to the data fields in an SCI-1 transmitted independent of the reverse-link grants and/or the SCI-3. That is, as described in greater detail below, data fields having a dedicated association with SCI-3 and/or the transmission of reverse-link grants may be contained within SCI-2. For example, in some embodiments, regardless of whether the block of reverse-link grants is transmitted with user data (e.g., forward link data) or not, the SCI-1 may not require an additional flag to indicate the presence or absence of user data on the PSSCH. Instead, the anchor sidelink communication module 608 may configure the SCI-1 to treat SCI-3 and user data substantially equivalently. Accordingly, any information regarding the SCI-3 and/or any additional information regarding the user data may be captured in SCI-2 instead.

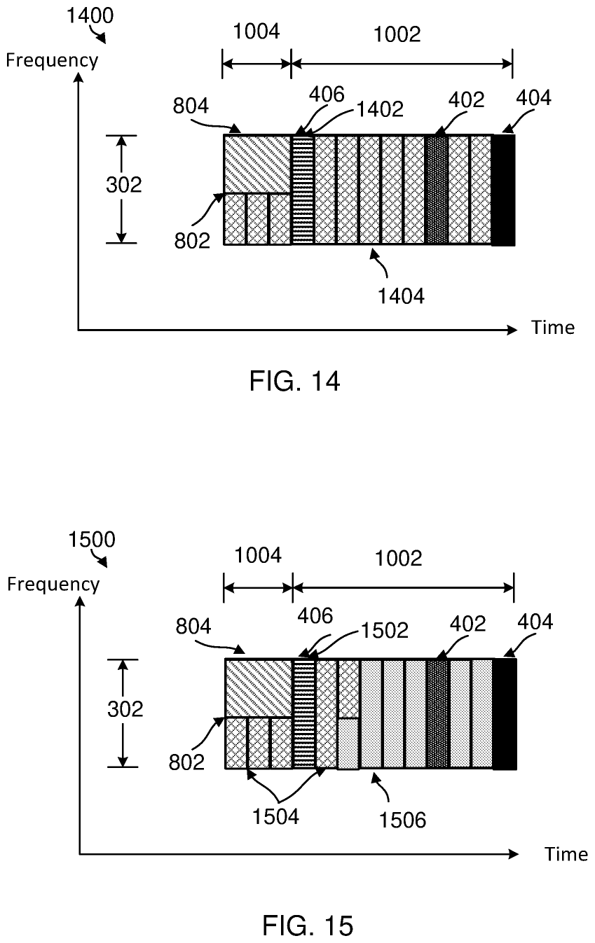

At block 1306, the anchor UE 600 may transmit, over the PSSCH, the SCI-2 rate matched from the DMRS 406 (see, e.g., FIG. 14 as discussed further below). In some aspects, the DMRS 406 may be transmitted over the PSSCH after a first time period 1004. Accordingly, the SCI-2 may be rate matched after the first time period 1004 from a start of the DMRS 406. Moreover, in some embodiments, rate matching the SCI-2 may involve overlapping the SCI-2 with the DMRS 406 such that a particular block of resources may contain both a portion of the DMRS 406 and a portion of the SCI-2.

According to some aspects, the SCI-2 may include data fields associated with SCI-3, as described above. More specifically, in some embodiments, the SCI-2 may include a data field configured to indicate whether the PSSCH includes user data or not, a data field configured to indicate the presence of the SCI-3 on the PSSCH, a data field configured to indicate a structure of the SCI-3, such as the length (e.g., size) of the SCI-3, a data field configured to provide parsing instructions associated with the SCI-3, or a suitable combination thereof. The SCI-2 may also indicate a number of client UEs 500 associated with the SCI-3 and/or the number of reverse-link grants included in the SCI-3. Further, in some embodiments, the SCI-3 may have the same MCS level and/or the same beta offset of resource allocation as SCI-2. In such embodiments, the SCI-2 may omit data fields indicating the MCS level and/or beta offset of resource allocation of the SCI-3, as the anchor UE 600 and/or the client UE 500 may be preconfigured to use the MCS level and/or beta offset of SCI-2 and, by association, SCI-3. In embodiments where the MCS level and/or the beta offset of SCI-3 is different from the MCS level and/or the beta offset of SCI-2, the SCI-2 may include one or more data fields configured to respectively indicate the MCS level and/or beta offset of the SCI-3.

At decision block 1308, the anchor UE 600 may determine whether the PSSCH includes user data (e.g., the anchor UE 600 may determine whether it has any user data to transmit via forward link in the PSSCH in that slot). If it is determined at decision block 1308 that there is no user data to transmit in the forward link with the SCI-3, then the process 1300 proceeds to block 1310.

At block 1310, the anchor UE 600 may transmit, over the PSSCH, the SCI-3 rate matched from a first resource element at a start 802 of the PSSCH. For example, the SCI-3 may be rate matched such that the SCI-3 occupies any available and/or unreservered resource elements on the PSSCH following the start 802 of the PSSCH. Accordingly, in some embodiments, with reference as example to FIG. 14, a first portion of the SCI-3 may be rate matched within a first time period 1004 preceding the DMRS 406 signal, and rate matching of the SCI-3 may continue with a second portion of the SCI-3 rate matched from the SCI-2 and/or the DMRS 406, such as to the end of the slot.

Returning to decision block 1308, if it is determined that there is user data to transmit in the forward link with the SCI-3, then the process 1300 proceeds to block 1312. At block 1312, the anchor UE 600 may transmit the SCI-3 and the user data over the PSSCH 320. For example, the SCI-3 may be rate matched such that the SCI-3 occupies any available and/or unreservered resource elements on the PSSCH following the start 802 of the PSSCH. Accordingly, in some embodiments, with reference as example to FIG. 15, a first portion of the SCI-3 may be rate matched within a first time period 1004 preceding the DMRS 406 signal. If there is more information of SCI-3 that did not fit within the first time period 1004, then rate matching of the SCI-3 may continue with a second portion of the SCI-3 rate matched from the SCI-2 and/or the DMRS 406, but not to the end of the slot. Instead, the user data may follow the end of SCI-3, either right after DMRS 406 and SCI-2, or after the last portion of SCI-3 is included after the DMRS 406/SCI-2. For example, the anchor UE 600 may transmit the user data following the first time period 1004, as the resource elements of the PSSCH within the first time period 1004 may be occupied and/or reserved for the SCI-3. To that end, in some embodiments, the anchor UE 600 may transmit the user data over the PSSCH following the SCI-3, as illustrated in FIG. 15.

Turning now to FIG. 14, exemplary sidelink resources 1400 having one or more reverse-link grants is provided. As shown, sidelink resources 1400 include SCI-1 on the PSCCH 804 and SCI-2 1402 and SCI-3 1404 on the PSSCH. The sidelink resources 1400 further illustrate SCI-2 1402 rate matched from the start of the DMRS 406, as described above with reference to block 1206. In the illustrated embodiment, the SCI-2 1402 and the DMRS 406 overlap in time. As further illustrated, the SCI-3 1404 is rate matched from a start 802 of the PSSCH up to the start of the DMRS 406, and continues in the second time period 1002 from the SCI-2 1402. Because no user data is included on the PSSCH in the example of FIG. 14, the transmission of the sidelink resources 1400 may be dedicated to information associated with the reverse-link grants included in the SCI-3 (which is rate matched across the full available PSSCH). To that end, the anchor UE 600 may transmit each portion of the sidelink resources 1400 (e.g., the SCI-1, the SCI-2, the DMRS, the SCI-3 etc.) regardless of whether forward link transmission is occurring on a sidelink (e.g., 251, 252, 254, 256) and/or to a particular client UE 500.

FIG. 15 illustrates an exemplary block diagram of sidelink resources 1500 having one or more reverse-link grants. In the illustrated embodiment, the sidelink resources 1500 includes SCI-1 on the PSCCH 804, and SCI-2 1502, SCI-3 1504, and user data 1506 on the PSSCH. As described with reference to the sidelink resources 1400 of FIG. 14, the sidelink resources 1500 illustrates the SCI-2 1502 rate matched from the start of the DMRS 406. Moreover, the SCI-3 1506 is rate matched from the start 802 of the PSSCH, and the rate matching of the SCI-3 1506 continues in the second time period 1002 from the end of SCI-2 1502. Within the second time period 1002, the SCI-3 1504 is rate matched to accommodate the user data. Thus, in comparison with the sidelink resources 1400 of FIG. 14, the SCI-3 1506 is rate matched to fewer resource elements (not across the full available PSSCH) such that the anchor UE 600 may transmit the user data 1506 on PSSCH using the remaining resource elements.

As described above, in some embodiments the anchor UE 600 may treat the SCI-3 1504 as user data from the perspective of control information. That is, for example, the SCI-1 on PSCCH 804 may remain unchanged whether the anchor UE 600 transmits the SCI-3 1506 with user data 1506 or not, as the SCI-3 1504 may be transmitted in the resource elements of the PSSCH that the user data may also occupy. Thus, as illustrated in FIG. 15, the anchor UE 600 may transmit the SCI-3 1504 as first user data and may transmit the user data 1506 as second user data on the PSSCH. More specifically, in some embodiments, the anchor UE 600 may transmit the user data following the SCI-3.

While FIGS. 13-15 are described above with reference to embodiments having the DMRS 406 transmitted after the first time period 1004, in some embodiments, the anchor UE 600 may transmit the DMRS 406 at a start 802 of the PSSCH (e.g., within or before the first time period 1004). In such embodiments, the anchor UE 600 may rate match the SCI-2 1502 from a start of the DMRS 406. The anchor UE 600 may further rate match the SCI-3 1504 from the SCI-2 1502. In such embodiments, the anchor UE 600 may rate match the SCI-3 1504 to occupy the remaining resource elements of the PSSCH (if no user data 1506) or to occupy a subset of the remaining resource elements of the PSSCH to accommodate user data 1506.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication, comprising:
determining, by a first user equipment (UE), a plurality of reverse-link grants for a respective plurality of UEs to transmit sidelink data to the first UE;
transmitting, by the first UE, first sidelink control information over a physical sidelink control channel (PSCCH); and
transmitting, by the first UE over a physical sidelink shared channel (PSSCH), a demodulation reference signal (DMRS) and second sidelink control information, the second sidelink control information comprising the plurality of reverse-link grants in a block.

2. The method of claim 1, wherein transmitting the DMRS comprises transmitting the DMRS on the PSSCH after a first time period.

3. The method of claim 2, wherein transmitting the second sidelink control information comprises:
rate matching the second sidelink control information from a first resource element after the PSCCH at a start of the first time period, beginning before a start of the DMRS.

4. The method of claim 2, wherein transmitting the second sidelink control information comprises:
rate matching a first portion of the second sidelink control information from a beginning of the DMRS in a second time period following the first time period;
returning back to a start of the first time period; and
rate matching a second portion of the second sidelink control information from a first resource element after the PSCCH at the start of the first time period up to the DMRS.

5. The method of claim 4, wherein transmitting the second sidelink control information comprises:
transmitting, during the first time period, the second portion of the second sidelink control information; and
transmitting, during the second time period, the first portion of the second sidelink control information.

6. The method of claim 5, wherein the second portion of the second portion of the second sidelink control information is configured to be decoded after the first portion.

7. The method of claim 2, further comprising:
transmitting, by the first UE, user data over the PSSCH during the first time period; and
rate matching the second sidelink control information from a start of the DMRS in a second time period following the first time period.

8. The method of claim 7, wherein transmitting the user data comprises:
transmitting a first portion of the user data over the PSSCH during the first time period; and
transmitting a second portion of the user data over the PSSCH during the second time period.

9. The method of claim 1, wherein:
transmitting the DMRS comprises transmitting the DMRS at a beginning of a first symbol on the PSSCH; and
transmitting the second sidelink control information comprises rate matching the second sidelink control information from a start of the DMRS.

10. The method of claim 1, further comprising:
rate matching the second sidelink control information.

11. The method of claim 1, further comprising:
indicating, by the first UE in the first sidelink control information, whether the PSSCH comprises user data or not.

12. The method of claim 11, further comprising:
selecting, by the first UE, a first rate matching rule in response to the PSSCH not comprising the user data,
wherein the first rate matching rule comprises rate matching a portion of the second sidelink control information in a first time period at a beginning of the PSSCH and before a start of the DMRS.

13. The method of claim 12, further comprising:
selecting, by the first UE, a second rate matching rule in response to the PSSCH comprising user data,
wherein the user data starts at a beginning of the PSSCH before the DMRS, and the second rate matching rule comprises beginning rate matching from a start of the DMRS.

14. The method of claim 1, wherein each of the plurality of reverse-link grants comprises a respective reverse-link grant identifier.

15. The method of claim 1, wherein the second sidelink control information further comprises a respective reverse-link grant identifier corresponding to each of the plurality of reverse-link grants.

16. The method of claim 1, wherein the second sidelink control information further comprises a respective user identifier corresponding to each of the plurality of UEs.

17. The method of claim 1, wherein the second sidelink control information further comprises an indication of a number of reverse-link grants included in the block.

18. The method of claim 1, further comprising:
identifying, by the first UE, a size of the second sidelink control information in the first sidelink control information.

19. A method of wireless communication, comprising:
determining, by a first user equipment (UE), a plurality reverse-link grants for a plurality of UEs to transmit sidelink data to the first UE;
transmitting, by the first UE, first sidelink control information over a physical sidelink control channel (PSCCH); and
transmitting, by the first UE, over a physical sidelink shared channel (PSSCH):
a demodulation reference signal (DMRS);
second sidelink control information configured to provide information related to third sidelink control information; and
the third sidelink control information comprising the plurality of reverse-link grants in a block.

20. The method of claim 19, wherein transmitting the DMRS comprises transmitting the DMRS on the PSSCH after a first time period.

21. The method of claim 20, further comprising:
indicating, by the first UE in the second sidelink control information, whether the PSSCH comprises user data or not.

22. The method of claim 21, further comprising, in response to the PSSCH not comprising user data:
rate matching the second sidelink control information from a start of the DMRS; and
rate matching the third sidelink control information from a first resource element at a start of the PSSCH, beginning before the DMRS and the second sidelink control information and continuing after the DMRS and the second sidelink control information.

23. The method of claim 22, wherein the second sidelink control information comprises a length of the third sidelink control information, and information indicating how to parse the block in the third sidelink control information.

24. The method of claim 21, further comprising, in response to the PSSCH comprising user data:
rate matching the second sidelink control information from a start of the DMRS;
rate matching the third sidelink control information from a first resource element at a start of the PSSCH, beginning before the DMRS and the second sidelink control information; and
including the user data after the DMRS.

25. The method of claim 24, further comprising:
continuing the rate matching of the third sidelink control information after the DMRS and the second sidelink control information before the user data over the PSSCH.

26. The method of claim 24, wherein the second sidelink control information comprises an indication of a beta offset for the third sidelink control information.

27. The method of claim 24, wherein the second sidelink control information comprises a block size of the third sidelink control information.

28. The method of claim 24, wherein the second sidelink control information comprises a number of the plurality of UEs.

29. The method of claim 19, wherein the transmitting over the PSSCH further comprises:
transmitting the DMRS as a first symbol on the PSSCH;
rate matching the second sidelink control information from a start of the DMRS; and
rate matching the third sidelink control information from an end of the second sidelink control information.

30. The method of claim 19, wherein the third sidelink control information further comprises UE identifiers for each of the plurality of UEs corresponding to each of the respective reverse-link grants.

31. A user equipment (UE), comprising:
a processor configured to determine a plurality of reverse-link grants for a respective plurality of UEs to transmit sidelink data to the user equipment; and
a transceiver configured to:
transmit first sidelink control information over a physical sidelink control channel (PSCCH); and
transmit, over a physical sidelink shared channel (PSSCH), a demodulation reference signal (DMRS) and second sidelink control information, the second sidelink control information comprising the plurality of reverse-link grants in a block.

32. The user equipment of claim 31, wherein the transceiver is configured to transmit the DMRS on the PSSCH after a first time period.

33. The user equipment of claim 32, wherein the processor is configured to:
rate match the second sidelink control information from a first resource element after the PSCCH at a start of the first time period, beginning before a start of the DMRS.

34. The user equipment of claim 32, wherein the processor is configured to:
rate match a first portion of the second sidelink control information from a beginning of the DMRS in a second time period following the first time period;
return back to a start of the first time period; and
rate match a second portion of the second sidelink control information from a first resource element after the PSCCH at the start of the first time period up to the DMRS.

35. The user equipment of claim 34, wherein the transceiver is configured to:
transmit, during the first time period, the second portion of the second sidelink control information; and
transmit, during the second time period, the first portion of the second sidelink control information.

36. The user equipment of claim 35, wherein the second portion of the second portion of the second sidelink control information is configured to be decoded after the first portion.

37. The user equipment of claim 32, wherein:
the transceiver is configured to transmit user data over the PSSCH during the first time period; and
the processor is configured to rate match the second sidelink control information from a start of the DMRS in a second time period following the first time period.

38. The user equipment of claim 37, wherein the transceiver is configured to:
transmit a first portion of the user data over the PSSCH during the first time period; and
transmit a second portion of the user data over the PSSCH during the second time period.

39. The user equipment of claim 31, wherein:
the transceiver is configured to transmit the DMRS at a beginning of a first symbol on the PSSCH; and
the processor is configured to rate match the second sidelink control information from a start of the DMRS.

40. The user equipment of claim 31, wherein the processor is configured to:
rate match the second sidelink control information.

41. The user equipment of claim 31, wherein the processor is further configured to:
indicate, in the first sidelink control information, whether the PSSCH comprises user data or not.

42. The user equipment of claim 41, wherein the processor is further configured to:
select a first rate matching rule in response to the PSSCH not comprising the user data,
wherein the first rate matching rule comprises rate matching a portion of the second sidelink control information in a first time period at a beginning of the PSSCH and before a start of the DMRS.

43. The user equipment of claim 42, wherein the processor is further configured to:
select a second rate matching rule in response to the PSSCH comprising user data,
wherein the user data starts at a beginning of the PSSCH before the DMRS, and the second rate matching rule comprises beginning rate matching from a start of the DMRS.

44. The user equipment of claim 31, wherein each of the plurality of reverse-link grants comprises a respective reverse-link grant identifier.

45. The user equipment of claim 31, wherein the second sidelink control information further comprises a respective reverse-link grant identifier corresponding to each of the plurality of reverse-link grants.

46. The user equipment of claim 31, wherein the second sidelink control information further comprises a respective user identifier corresponding to each of the plurality of UEs.

47. The user equipment of claim 31, wherein the second sidelink control information further comprises an indication of a number of reverse-link grants included in the block.

48. The user equipment of claim 31, wherein the processor is further configured to:
identify a size of the second sidelink control information in the first sidelink control information.

49. A user equipment (UE), comprising:
a processor configured to determine a plurality reverse-link grants for a plurality of UEs to transmit sidelink data to the user equipment; and
a transceiver configured to:
transmit first sidelink control information over a physical sidelink control channel (PSCCH); and
transmit over a physical sidelink shared channel (PSSCH):
a demodulation reference signal (DMRS);
second sidelink control information configured to provide information related to third sidelink control information; and
the third sidelink control information comprising the plurality of reverse-link grants in a block.

50. The user equipment of claim 49, wherein the transceiver is configured to transmit the DMRS on the PSSCH after a first time period.

51. The user equipment of claim 50, wherein the processor is further configured to:
indicate, in the second sidelink control information, whether the PSSCH comprises user data or not.

52. The user equipment of claim 51, wherein the processor is further configured, in response to the PSSCH not comprising user data, to:
rate match the second sidelink control information from a start of the DMRS; and
rate match the third sidelink control information from a first resource element at a start of the PSSCH, beginning before the DMRS and the second sidelink control information and continuing after the DMRS and the second sidelink control information.

53. The user equipment of claim 52, wherein the second sidelink control information comprises a length of the third sidelink control information, and information indicating how to parse the block in the third sidelink control information.

54. The user equipment of claim 51, wherein the processor is further configured, in response to the PSSCH comprising user data, to:
rate match the second sidelink control information from a start of the DMRS;
rate match the third sidelink control information from a first resource element at a start of the PSSCH, beginning before the DMRS and the second sidelink control information; and
include the user data after the DMRS.

55. The user equipment of claim 54, wherein the processor is further configured to:
continue the rate matching of the third sidelink control information after the DMRS and the second sidelink control information before the user data over the PSSCH.

56. The user equipment of claim 54, wherein the second sidelink control information comprises an indication of a beta offset for the third sidelink control information.

57. The user equipment of claim 54, wherein the second sidelink control information comprises a block size of the third sidelink control information.

58. The user equipment of claim 54, wherein the second sidelink control information comprises a number of the plurality of UEs.

59. The user equipment of claim 49, wherein:
the transceiver is further configured to transmit the DMRS as a first symbol on the PSSCH; and
the processor is further configured to:
rate match the second sidelink control information from a start of the DMRS; and
rate match the third sidelink control information from an end of the second sidelink control information.

60. The user equipment of claim 49, wherein the third sidelink control information further comprises UE identifiers for each of the plurality of UEs corresponding to each of the respective reverse-link grants.

61. A non-transitory computer-readable medium having program code recorded thereon, the program code comprising:
code for causing a first user equipment (UE) to determine a plurality of reverse-link grants for a respective plurality of UEs to transmit sidelink data to the first UE;
code for causing the first UE to transmit first sidelink control information over a physical sidelink control channel (PSCCH); and
code for causing the first UE to transmit, over a physical sidelink shared channel (PSSCH), a demodulation reference signal (DMRS) and second sidelink control information, the second sidelink control information comprising the plurality of reverse-link grants in a block.

62. The non-transitory computer-readable medium of claim 61, the program code further comprising:
code for causing the first UE to transmit the DMRS on the PSSCH after a first time period.

63. The non-transitory computer-readable medium of claim 62, the program code further comprising:
code for causing the first UE to rate match the second sidelink control information from a first resource element after the PSCCH at a start of the first time period, beginning before a start of the DMRS.

64. The non-transitory computer-readable medium of claim 62, the program code further comprising:
code for causing the first UE to rate match a first portion of the second sidelink control information from a beginning of the DMRS in a second time period following the first time period; returning back to a start of the first time period; and
code for causing the first UE to rate match a second portion of the second sidelink control information from a first resource element after the PSCCH at the start of the first time period up to the DMRS.

65. The non-transitory computer-readable medium of claim 64, the program code further comprising:
code for causing the first UE to transmit, during the first time period, the second portion of the second sidelink control information; and
code for causing the first UE to transmit, during the second time period, the first portion of the second sidelink control information.

66. The non-transitory computer-readable medium of claim 65, wherein the second portion of the second portion of the second sidelink control information is configured to be decoded after the first portion.

67. The non-transitory computer-readable medium of claim 62, the program code further comprising:
code for causing the first UE to transmit user data over the PSSCH during the first time period; and
code for causing the first UE to rate match the second sidelink control information from a start of the DMRS in a second time period following the first time period.

68. The non-transitory computer-readable medium of claim 67, the program code further comprising:
code for causing the first UE to transmit a first portion of the user data over the PSSCH during the first time period; and
code for causing the first UE to transmit a second portion of the user data over the PSSCH during the second time period.

69. The non-transitory computer-readable medium of claim 61, the program code further comprising:
code for causing the first UE to transmit the DMRS comprises transmitting the DMRS at a beginning of a first symbol on the PSSCH; and
code for causing the first UE to transmit the second sidelink control information comprises rate matching the second sidelink control information from a start of the DMRS.

70. The non-transitory computer-readable medium of claim 61, the program code further comprising:
code for causing the first UE to rate match the second sidelink control information.

71. The non-transitory computer-readable medium of claim 61, the program code further comprising:
code for causing the first UE to indicate, in the first sidelink control information, whether the PSSCH comprises user data or not.

72. The non-transitory computer-readable medium of claim 71, the program code further comprising:
code for causing the first UE to select a first rate matching rule in response to the PSSCH not comprising the user data,
wherein the first rate matching rule comprises rate matching a portion of the second sidelink control information in a first time period at a beginning of the PSSCH and before a start of the DMRS.

73. The non-transitory computer-readable medium of claim 72, the program code further comprising:
code for causing the first UE to select a second rate matching rule in response to the PSSCH comprising user data,
wherein the user data starts at a beginning of the PSSCH before the DMRS, and the second rate matching rule comprises beginning rate matching from a start of the DMRS.

74. The non-transitory computer-readable medium of claim 61, wherein each of the plurality of reverse-link grants comprises a respective reverse-link grant identifier.

75. The non-transitory computer-readable medium of claim 61, wherein the second sidelink control information further comprises a respective reverse-link grant identifier corresponding to each of the plurality of reverse-link grants.

76. The non-transitory computer-readable medium of claim 61, wherein the second sidelink control information further comprises a respective user identifier corresponding to each of the plurality of UEs.

77. The non-transitory computer-readable medium of claim 61, wherein the second sidelink control information further comprises an indication of a number of reverse-link grants included in the block.

78. The non-transitory computer-readable medium of claim 61, the program code further comprising:
code for causing the first UE to identify a size of the second sidelink control information in the first sidelink control information.

79. A non-transitory computer-readable medium having program code recorded thereon, the program code comprising:
code for causing a first user equipment (UE) to determine a plurality reverse-link grants for a plurality of UEs to transmit sidelink data to the first UE;
code for causing the first UE to transmit first sidelink control information over a physical sidelink control channel (PSCCH); and
code for causing the first UE to transmit, over a physical sidelink shared channel (PSSCH):
a demodulation reference signal (DMRS);
second sidelink control information configured to provide information related to third sidelink control information; and
the third sidelink control information comprising the plurality of reverse-link grants in a block.

80. The non-transitory computer-readable medium of claim 79, the program code further comprising:
code for causing the first UE to transmit the DMRS on the PSSCH after a first time period.

81. The non-transitory computer-readable medium of claim 80, the program code further comprising:
code for causing the first UE to indicate, in the second sidelink control information, whether the PSSCH comprises user data or not.

82. The non-transitory computer-readable medium of claim 81, the program code further comprising:
code for causing the first UE, in response to the PSSCH not comprising user data to:
rate match the second sidelink control information from a start of the DMRS; and
rate match the third sidelink control information from a first resource element at a start of the PSSCH, beginning before the DMRS and the second sidelink control information and continuing after the DMRS and the second sidelink control information.

83. The non-transitory computer-readable medium of claim 82, wherein the second sidelink control information comprises a length of the third sidelink control information, and information indicating how to parse the block in the third sidelink control information.

84. The non-transitory computer-readable medium of claim 81, the program code further comprising:
code for causing the first UE, in response to the PSSCH comprising user data, to:
rate match the second sidelink control information from a start of the DMRS;
rate match the third sidelink control information from a first resource element at a start of the PSSCH, beginning before the DMRS and the second sidelink control information; and
include the user data after the DMRS.

85. The non-transitory computer-readable medium of claim 84, the program code further comprising:
code for causing the first UE to continue the rate matching of the third sidelink control information after the DMRS and the second sidelink control information before the user data over the PSSCH.

86. The non-transitory computer-readable medium of claim 84, wherein the second sidelink control information comprises an indication of a beta offset for the third sidelink control information.

87. The non-transitory computer-readable medium of claim 84, wherein the second sidelink control information comprises a block size of the third sidelink control information.

88. The non-transitory computer-readable medium of claim 84, wherein the second sidelink control information comprises a number of the plurality of UEs.

89. The non-transitory computer-readable medium of claim 79, the program code further comprising:
code for causing the first UE to transmit the DMRS as a first symbol on the PSSCH;
code for causing the first UE to rate match the second sidelink control information from a start of the DMRS; and
code for causing the first UE to rate match the third sidelink control information from an end of the second sidelink control information.

90. The non-transitory computer-readable medium of claim 79, wherein the third sidelink control information further comprises UE identifiers for each of the plurality of UEs corresponding to each of the respective reverse-link grants.

91. A user equipment (UE), comprising:
means for determining a plurality of reverse-link grants for a respective plurality of UEs to transmit sidelink data to the user equipment;
means for transmitting first sidelink control information over a physical sidelink control channel (PSCCH); and
means for transmitting, over a physical sidelink shared channel (PSSCH), a demodulation reference signal (DMRS) and second sidelink control information, the second sidelink control information comprising the plurality of reverse-link grants in a block.

92. The user equipment of claim 91, wherein the means for transmitting the DMRS comprises:
means for transmitting the DMRS on the PSSCH after a first time period.

93. The user equipment of claim 92, wherein the means for transmitting the second sidelink control information comprises:
means for rate matching the second sidelink control information from a first resource element after the PSCCH at a start of the first time period, beginning before a start of the DMRS.

94. The user equipment of claim 92, wherein the means for transmitting the second sidelink control information comprises:
means for rate matching a first portion of the second sidelink control information from a beginning of the DMRS in a second time period following the first time period;
means for returning back to a start of the first time period; and
means for rate matching a second portion of the second sidelink control information from a first resource element after the PSCCH at the start of the first time period up to the DMRS.

95. The user equipment of claim 94, wherein the means for transmitting the second sidelink control information comprises:
means for transmitting, during the first time period, the second portion of the second sidelink control information; and
means for transmitting, during the second time period, the first portion of the second sidelink control information.

96. The user equipment of claim 95, wherein the second portion of the second portion of the second sidelink control information is configured to be decoded after the first portion.

97. The user equipment of claim 92, further comprising:
means for transmitting, by the user equipment, user data over the PSSCH during the first time period; and
means for rate matching the second sidelink control information from a start of the DMRS in a second time period following the first time period.

98. The user equipment of claim 97, wherein the means for transmitting the user data comprises:
means for transmitting a first portion of the user data over the PSSCH during the first time period; and
means for transmitting a second portion of the user data over the PSSCH during the second time period.

99. The user equipment of claim 91, wherein:
the means for transmitting the DMRS comprises means for transmitting the DMRS at a beginning of a first symbol on the PSSCH; and
the means for transmitting the second sidelink control information comprises means for rate matching the second sidelink control information from a start of the DMRS.

100. The user equipment of claim 91, further comprising:
means for rate matching the second sidelink control information.

101. The user equipment of claim 91, further comprising:
means for indicating, by the user equipment in the first sidelink control information, whether the PSSCH comprises user data or not.

102. The user equipment of claim 101, further comprising:
means for selecting, by the user equipment, a first rate matching rule in response to the PSSCH not comprising the user data,
wherein the first rate matching rule comprises rate matching a portion of the second sidelink control information in a first time period at a beginning of the PSSCH and before a start of the DMRS.

103. The user equipment of claim 102, further comprising:
means for selecting, by the user equipment, a second rate matching rule in response to the PSSCH comprising user data,
wherein the user data starts at a beginning of the PSSCH before the DMRS, and the second rate matching rule comprises beginning rate matching from a start of the DMRS.

104. The user equipment of claim 91, wherein each of the plurality of reverse-link grants comprises a respective reverse-link grant identifier.

105. The user equipment of claim 91, wherein the second sidelink control information further comprises a respective reverse-link grant identifier corresponding to each of the plurality of reverse-link grants.

106. The user equipment of claim 91, wherein the second sidelink control information further comprises a respective user identifier corresponding to each of the plurality of UEs.

107. The user equipment of claim 91, wherein the second sidelink control information further comprises an indication of a number of reverse-link grants included in the block.

108. The user equipment of claim 91, further comprising:
means for identifying, by the user equipment, a size of the second sidelink control information in the first sidelink control information.

109. A user equipment (UE), comprising:
means for determining a plurality reverse-link grants for a plurality of UEs to transmit sidelink data to the user equipment;
means for transmitting first sidelink control information over a physical sidelink control channel (PSCCH); and
means for transmitting over a physical sidelink shared channel (PSSCH):
a demodulation reference signal (DMRS);
second sidelink control information configured to provide information related to third sidelink control information; and
the third sidelink control information comprising the plurality of reverse-link grants in a block.

110. The user equipment of claim 109, wherein the means for transmitting the DMRS comprises:
means for transmitting the DMRS on the PSSCH after a first time period.

111. The user equipment of claim 110, further comprising:
means for indicating, in the second sidelink control information, whether the PSSCH comprises user data or not.

112. The user equipment of claim 111, further comprising, in response to the PSSCH not comprising user data:
means for rate matching the second sidelink control information from a start of the DMRS; and
means for rate matching the third sidelink control information from a first resource element at a start of the PSSCH, beginning before the DMRS and the second sidelink control information and continuing after the DMRS and the second sidelink control information.

113. The user equipment of claim 112, wherein the second sidelink control information comprises a length of the third sidelink control information, and information indicating how to parse the block in the third sidelink control information.

114. The user equipment of claim 111, further comprising, in response to the PSSCH comprising user data:
means for rate matching the second sidelink control information from a start of the DMRS;
means for rate matching the third sidelink control information from a first resource element at a start of the PSSCH, beginning before the DMRS and the second sidelink control information; and
means for including the user data after the DMRS.

115. The user equipment of claim 114, further comprising:
means for continuing the rate matching of the third sidelink control information after the DMRS and the second sidelink control information before the user data over the PSSCH.

116. The user equipment of claim 114, wherein the second sidelink control information comprises an indication of a beta offset for the third sidelink control information.

117. The user equipment of claim 114, wherein the second sidelink control information comprises a block size of the third sidelink control information.

118. The user equipment of claim 114, wherein the second sidelink control information comprises a number of the plurality of UEs.

119. The user equipment of claim 109, wherein the means for transmitting over the PSSCH further comprises:
means for transmitting the DMRS as a first symbol on the PSSCH;
means for rate matching the second sidelink control information from a start of the DMRS; and
means for rate matching the third sidelink control information from an end of the second sidelink control information.

120. The user equipment of claim 109, wherein the third sidelink control information further comprises UE identifiers for each of the plurality of UEs corresponding to each of the respective reverse-link grants.
